(19) United States
(12) Patent Application Publication
(10) Pub. No.: US 2026/0188289 A1
(43) Pub. Date: Jul. 2, 2026

(54) SIGNAL CONCENTRATING WAVEGUIDE ARRAY

(71) Applicant: Sensia Netherlands B.V., Rotterdam (NL)

(72) Inventor: Gregor James Brown, Prestwick (GB)

(21) Appl. No.: 19/005,327

(22) Filed: Dec. 30, 2024

(51) Int. Cl. G10K 11/04; G01N 29/024

(52) U.S. Cl. CPC G10K 11/04; G01N 29/024

(57) ABSTRACT

A waveguide array is configured to convey ultrasonic soundwaves. The waveguide array includes a plurality of waveguide elements. Each of the waveguide elements defines a proximal end configured to receive the ultrasonic soundwaves produced by the transducer and a distal end opposing the proximal end. A cross-sectional width of each of the waveguide elements is less than a wavelength of the ultrasonic soundwaves. An inward area of the waveguide array at the proximal ends of the waveguide elements is greater than an outward area of the waveguide array at the distal ends of the waveguide elements.

### BACKGROUND

The present application relates generally to the field of ultrasonic transducers. More specifically, the present application relates to the field of waveguide arrays configured to be utilized with ultrasonic transducers.

### SUMMARY OF THE INVENTION

One embodiment of the present disclosure relates to a waveguide array configured to convey ultrasonic soundwaves. The waveguide array includes a plurality of waveguide elements. Each of the waveguide elements defines a proximal end configured to receive the ultrasonic soundwaves from a transducer and a distal end opposing the proximal end. A cross-sectional width of each of the waveguide elements is less than a wavelength of the ultrasonic soundwaves. An inward area of the waveguide area at the proximal ends of the waveguide elements is greater than an outward area of the waveguide array at the distal ends of the waveguide elements. First distances between centers of adjacent of the waveguide elements at the proximal ends of the waveguide elements are greater than second distances between the centers of the adjacent of the waveguide elements at the distal ends of the waveguide elements.

In some embodiments, a cross-sectional area of each of the waveguide elements varies along a length of each of the waveguide elements. In some embodiments, a first sum of the cross-sectional areas of the waveguide elements at the proximal ends of the waveguide elements is greater than a second sum of the cross-sectional areas of the waveguide elements at the distal ends of the waveguide elements.

In some embodiments, the waveguide array also includes a waveguide housing. In some embodiments, the waveguide housing includes a housing proximal end configured to interface with the transducer and a housing distal end opposing the housing proximal end. In some embodiments, the waveguide housing defines an opening extending through the waveguide housing between the housing proximal end and the housing distal end. In some embodiments, the opening is larger proximate the housing proximal end than proximate the housing distal end. In some embodiments, the waveguide elements are disposed within the opening of the waveguide housing.

In some embodiments, the waveguide array also includes a filling disposed within the opening of the waveguide housing. In some embodiments, a first acoustic impedance of the waveguide elements is higher than a second acoustic impedance of the filling. In some embodiments, the filling is disposed between the waveguide elements.

In some embodiments, the transducer is disposed within the housing. In some embodiments, the housing proximal end of the waveguide housing is configured to couple to the housing to acoustically couple the proximal ends of the waveguide elements with the transducer. In some embodiments, at least one of the proximal ends or the distal ends of each of the waveguide elements are acoustically coupled to at the at least one of the proximal ends or the distal ends of the waveguide elements. In some embodiments, at least one of the proximal ends or the distal ends of each of the waveguide elements are coupled to form a continuous surface at the at least one of the proximal ends or the distal ends of the waveguide elements.

Another implementation of the present disclosure is an ultrasonic sensor system. The ultrasonic sensor system includes a pair of ultrasonic sensors. Each of the ultrasonic sensors includes a transducer and a waveguide array. The transducer is configured to produce ultrasonic soundwaves and receive the ultrasonic soundwaves from the transducer of the other of the ultrasonic sensors. The waveguide array is aligned with the transducer. The waveguide array includes a waveguide housing and a plurality of waveguide elements. The waveguide housing includes a housing proximal end configured to interface with the transducer and a housing distal end opposing the housing proximal end. The plurality of waveguide elements are disposed within the waveguide housing. A first cross-sectional width of each of the waveguide elements proximate the housing proximal end of the housing is larger than a second cross-sectional width of each of the waveguide elements proximate the housing distal end of the housing. First distances between centers of adjacent of the waveguide elements proximate the transducer are greater than second distances between the centers of the adjacent of the waveguide elements distal to the transducer.

In some embodiments, the ultrasonic sensor system also includes a controller. In some embodiments the controller is configured to provide, to the transducer of a first of the ultrasonic sensors, a command for the transducer of the first of the ultrasonic sensors to produce the ultrasonic soundwaves. In some embodiments, the transducer of the first of the ultrasonic sensors is configured to provide the ultrasonic soundwaves through the waveguide array of the first of the ultrasonic sensors into a flow of a fluid through a conduit. In some embodiments, the controller is configured to receive, from the transducer of a second of the ultrasonic sensors, data corresponding to the ultrasonic soundwaves received by the second of the transducer of the second of the ultrasonic sensors through the waveguide array of the second of the ultrasonic sensors. In some embodiments, the controller is configured to determine, based on the data, at least one of a property of the fluid or a property of the flow of the fluid between the first of the ultrasonic sensors and the second of the ultrasonic sensors.

In some embodiments, the at least one of the property of the fluid or the property of the flow of the fluid is a velocity of the fluid flowing between the first of the ultrasonic sensors and the second of the ultrasonic sensors. In some embodiments, each of the waveguide arrays are at least one of partially disposed in a cavity in communication with the conduit or extending outside of an inner surface of the conduit.

In some embodiments, a first sum of first cross-sectional areas of the waveguide elements at proximal ends of the waveguide elements proximate the transducer is greater than a second sum of second cross-sectional areas of the waveguide elements at distal ends of the waveguide elements.

In some embodiments, the waveguide housing defines an opening extending from the housing proximal end to the housing distal end. In some embodiments, the waveguide array further comprises a filling disposed within the opening of the waveguide housing. In some embodiments, a first acoustic impedance of the waveguide elements is higher than a second acoustic impedance of the filling.

In some embodiments, a first cross-sectional area of the housing distal end of the waveguide housing is smaller than a second cross-sectional area of the housing proximal end of the waveguide housing.

Another implementation of the present disclosure is a method of measuring at least one of a property of a fluid or a property of a flow of the fluid, according to some embodiments. In some embodiments, the method includes providing, via a controller, a command to a first transducer for the first transducer to produce ultrasonic soundwaves. In some embodiments, the first transducer is configured to provide the ultrasonic soundwaves to a first waveguide array. In some embodiments, the first waveguide array includes a plurality of first waveguide elements. In some embodiments, a cross-sectional width of each of the first waveguide elements is less than a wavelength of the ultrasonic soundwaves. In some embodiments, a first cross-sectional area of the first waveguide array proximate the first transducer is greater than a second cross-sectional area of the first waveguide array distal to the first transducer. A first area of a first circumscribed circle extending through centers of peripheral of the first waveguide elements proximate the first transducer is greater than a second area of a second circumscribed circle extending through the centers of the peripheral of the first waveguide elements distal to the first transducer. In some embodiments, the method includes receiving, from a second transducer, data corresponding to the ultrasonic soundwaves received by the second transducer from a second waveguide array. In some embodiments, the second waveguide array includes a plurality of second waveguide elements. In some embodiments, the cross-sectional width of each of the second waveguide elements is less than the wavelength of the ultrasonic soundwaves. In some embodiments, a first cross-sectional area of the second waveguide array proximate the second transducer is greater than a second cross-sectional area of the second waveguide array distal to the second transducer. In some embodiments, the method includes determining, based on the data, the at least one of the property of the fluid or the property of the flow of the fluid between the first transducer and the second transducer.

In some embodiments, the flow of the fluid is through a conduit. In some embodiments, the first waveguide array is at least one of partially disposed in a first cavity in communication with the conduit or extending outside of an inner surface of the conduit. In some embodiments, the second waveguide array is at least one of partially disposed in a second cavity in communication with the conduit or extending outside of the inner surface of the conduit.

In some embodiments, first distances between centers of adjacent of the first waveguide elements proximate the first transducer are greater than second distances between the centers of the adjacent of the first waveguide elements distal to the first transducer and third distances between centers of adjacent of the second waveguide elements proximate the second transducer are greater than fourth distances between the centers of the adjacent of the second waveguide elements distal to the second transducer.

In some embodiments, the at least one of the property of the fluid or the property of the flow of the fluid of the flow of the fluid is a velocity of the flow of the fluid between the first waveguide array and the second waveguide array.

In some embodiments, a third area of a third circumscribed circle extending through centers of peripheral of the second waveguide elements proximate the second transducer is greater than a fourth circumscribed circle extending through the centers of the peripheral of the second waveguide elements distal to the second transducer.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a schematic diagram of a system including an ultrasonic measurement system and a conduit, according to some embodiments.

FIG. 2 is a perspective sectional view of an example configuration of the ultrasonic measurement system of the system of FIG. 1, according to some embodiments.

FIG. 3 is a perspective sectional view of another example configuration of the ultrasonic measurement system of the system of FIG. 1, according to some embodiments.

FIG. 4 is a detail view of a portion of the ultrasonic measurement system of FIG. 3, according to some embodiments.

FIG. 5 is an exploded view of a transducer of an ultrasonic sensor of the ultrasonic measurement system of FIG. 1, according to some embodiments.

FIG. 6 is a perspective view of an example ultrasonic sensor of the ultrasonic measurement system of FIG. 2.

FIG. 7 is a section view of the ultrasonic sensor of FIG. 6.

FIG. 8 is a section view of another example ultrasonic sensor.

FIG. 9 is a section view of an example conical window of an example ultrasonic sensor.

FIG. 10 is a section view of the ultrasonic sensor of FIG. 8 emitting ultrasonic soundwaves.

FIG. 11 is a section view of an embodiment of an ultrasonic sensor of the ultrasonic measurement system of FIG. 3 with an example waveguide array, according to some embodiments.

FIG. 12 is a section view of another example waveguide array for the ultrasonic sensor of FIG. 11, according to some embodiments.

FIG. 13 is another section view of the waveguide array of FIG. 12 taken along plane A-A of FIG. 12, according to some embodiments.

FIG. 14 is yet another section view of the waveguide array of FIG. 12 taken along plane B-B of FIG. 12, according to some embodiments.

FIG. 15 is a section view of a waveguide element of the waveguide array of FIG. 12, according to some embodiments.

FIG. 16 is a section view of a waveguide housing of the waveguide array of FIG. 12, according to some embodiments.

FIG. 17 is a section view of the ultrasonic sensor of FIG. 11 emitting ultrasonic soundwaves, according to some embodiments.

FIG. 18 is an example graph of signal amplitude versus time of ultrasonic soundwaves emitted by the ultrasonic sensor of FIG. 6.

FIG. 19 is an example graph of signal amplitude versus time of ultrasonic soundwaves emitted by the ultrasonic sensor of FIG. 8.

FIG. 20 is an example graph of signal amplitude versus time of ultrasonic soundwaves emitted by the ultrasonic sensor of FIG. 12, according to some embodiments.

### DETAILED DESCRIPTION

Before turning to the FIGURES, which illustrate the exemplary embodiments in detail, it should be understood that the present application is not limited to the details or methodology set forth in the description or illustrated in the FIGURES. It should also be understood that the terminology is for the purpose of description only and should not be regarded as limiting.

### Overview

In the landscape of industrial operations (e.g., hydrocarbon transportation, hydrocarbon production, fluid storage, etc.), the deployment of sensors (e.g., composition sensors, temperature sensors, etc.) is critical for optimizing operations, ensuring safety, and maximizing efficiency. Sensors play a crucial role by providing real-time data and monitoring parameters throughout industrial processes. Specifically, ultrasonic sensors (e.g., sonar sensors, acoustic sensors, etc.) may be utilized for a variety of applications. For example, ultrasonic sensors may be used to measure a distance to an object (e.g., an object on a production line, etc.), to measure a fluid level in a tank (e.g., a storage vessel, etc.), thickness measurements of materials (e.g., during manufacturing, during machining, etc.), sensing a flow through a fluid transportation network (e.g., a conduit, a pipeline, etc.), or to measure a characteristic of a flow of a fluid (e.g., a velocity of a fluid, a flow rate of a fluid, etc.). In measurement applications, high frequencies may be favored, whereas lower frequencies are more commonly used in processing applications such as cleaning or welding. The ultrasonic sensors may include high frequency transducers constructed from thin disks of piezoceramic material, incorporated into a transducer assembly. In some instances, the ultrasonic sensors include disks of piezoceramic material with a diameter in a range of approximately 10 mm to 25 mm for many practical applications.

In order to monitor a fluid flowing through the fluid transportation network, some operators (e.g., energy companies, hydrocarbon transportation companies, midstream operators, etc.) may utilize the ultrasonic measurement systems to determine a velocity or a flow rate of the fluid flowing through the fluid transportation network (e.g., ultrasonic flow meters, transit time ultrasonic flow meters, etc.). To monitor the fluid flowing through the fluid transportation network, the ultrasonic measurement system may include ultrasonic sensor pairs that include two ultrasonic sensors arranged within or around a periphery of a conduit (e.g., a flow conduit, etc.) of the fluid transportation network that align with each other, where a first of the ultrasonic sensors is positioned upstream of a second of the ultrasonic sensors. As a result, an ultrasonic path between the first of the ultrasonic sensors and the second of the ultrasonic sensors may be oriented at an angle that is non-normal (e.g., at an angle other than 90 degrees, etc.) to a primary axis of the conduit.

The ultrasonic sensor pairs may be utilized by the ultrasonic measurement system to determine (i) a first travel time of a first ultrasonic signal emitted by the first of the ultrasonic sensors and received by the second of the ultrasonic sensors along the ultrasonic path between the first of the ultrasonic sensors and the second of the ultrasonic sensors and (ii) a second travel time of a second ultrasonic signal emitted by the second of the ultrasonic sensors and received by the first of the ultrasonic sensors along the ultrasonic path between the first of the ultrasonic sensors and the second of the ultrasonic sensors (e.g., travel time analysis, etc.). By utilizing the first travel time of the first ultrasonic signal and the second travel time of the second ultrasonic signal, the ultrasonic measurement system may determine the velocity or the flow rate of the fluid flowing through the fluid transportation network. The operator may utilize the velocity or the flow rate of the fluid flowing through the fluid transportation network for accounting/allocation or custody transfer of fluid or determine control decisions associated with the fluid transportation network. An important characteristic of measurements of the ultrasonic measurement system for such applications is linearity (e.g., how closely a relationship between a flowrate of the fluid and a calculated flowrate determined based on measurements of the ultrasonic sensor conforms to a straight line, etc.). When the measurements of the ultrasonic measurement system are highly linear, it is easier to achieve high accuracy without having to perform an extensive calibrations that may rely on knowledge of variables such as the viscosity of the flowing fluid.

In some instances, the ultrasonic measurement system may include multiple ultrasonic sensor pairs that include ultrasonic sensors arranged within or around the periphery of the conduit in order to determine multiple travel times of ultrasonic signals between each of the pairs of the ultrasonic sensors. By using the travel times of the ultrasonic signals between the ultrasonic sensors of the ultrasonic sensor pair to determine the velocity of the flow rate of the fluid, a determination of the velocity or the flow rate of the fluid may be achieved. One method of arranging the pairs of ultrasonic sensors around the periphery of the conduit is to locate the ultrasonic paths on chords prescribed by a numerical integration method, such as Gaussian integration. For example, a 4-chord ultrasonic measurement system with a circular cross-section and ultrasonic path locations prescribed by the Gauss-Jacobi integration method would have ultrasonic paths that are located in chordal planes at heights of approximately +/−0.309 R and +/−0.809 R, where R is a radius of the conduit. The ultrasonic paths located in these chordal planes must be at a non-normal angle to the primary axis of the conduit in order for the transit times to be sensitive to the flow velocity of the fluid in the axial direction through the conduit.

In some instances, the ultrasonic sensors configured to monitor the fluid flowing through the fluid transportation network use transducers disposed within housings at least partially disposed within cavities defined by a wall of the conduit (e.g., a pipe wall, etc.). Each of the housings may include an emission window (e.g., a housing tip, etc., etc.) configured to (i) receive soundwaves from the transducer and provide the soundwaves from the transducer into the fluid and (i) receive the soundwaves from other of the transducers (e.g., a paired transducer, the transducer of the paired ultrasonic sensor, etc.) and provide the soundwaves from the other of the transducers to the transducer to so that the travel time of the soundwaves between the transducers can be measured by the ultrasonic measurement system. In order to orientate each of the transducers and each of the corresponding of the emission windows at the angles that are non-normal to the primary axis of the conduit, the housings may also be oriented at angles that are non-normal to the primary axis of the conduit. For example, the housing may be orientated at the angles that are non-normal to the primary axis of the conduit such that an emission face (e.g., a front face, etc.) of the emission window is not tangential to an inner surface of the wall of the conduit.

Since the angle of the housing may result in the emission face of the emission window of the housing not being tangential (e.g., flush, etc.) with an inside surface of the wall of the conduit, the cavity may include a cavity opening (e.g., an opening, a semi-cylindrical cavity, a recess, etc.) positioned in front of the ultrasonic sensor (e.g., in front of the emission face of the emission window, etc.) that is equal to or larger in diameter than the housing or the transducer. The cavity opening defined in the wall of the conduit may allow for the ultrasonic signals emitted and received by the ultrasonic sensors to follow a well-defined ultrasonic path through the flowing fluid, whereas introducing a signal without the cavity, for example by transmitting through an unbroken wall of the conduit can result in greater uncertainty in the ultrasonic path and ultrasonic signals with lower signal-to-noise ratio.

However, in some instances, the fluid flowing through the conduit may recirculate (e.g., reflow, circulate, etc.) in the cavity openings, which may influence (e.g., skew, have error introduced into, etc.) a measurement of transit times along ultrasonic paths between the ultrasonic sensors. The recirculation in the cavities can lead to inaccurate chordal velocity results and non-linearity. For example, with a 4-chord multipath ultrasonic where the transducers and/or the housings of the ultrasonic sensors are relatively large in scale compared to the conduit (e.g., a conduit with a diameter of 100 mm with a transducer housing with a diameter of 25 mm, or a ratio of 4:1), non-linearities can be equal to approximately 1% over a Reynolds number span from 10,000 to 1,000,000. Additionally, the influence of recirculation of the fluid in the cavity openings may be dependent on a size of the cavity openings relative to a size of the conduit. For example, in large diameter conduits where the cavity openings are relatively small when compared to the large diameter of the conduits, the related non-linearity can be reduced to a level that is negligible. Eliminating the cavity, for example by protruding the emission window of the ultrasonic sensor past the inside surface of the wall of the conduit into the flow of the fluid, or filling the cavity with another material can result in other effects that can be detrimental to achieving high accuracy measurements from the ultrasonic measurement system.

Additionally, smaller transducers (e.g., transducers with smaller diameters, smaller transducers disposed in housings with smaller diameters, etc.) can be difficult to manufacture and may not generate sufficiently strong signals for measurements across conduits with larger diameters. For example, transducers with diameter of 10 mm to 25 mm are typically utilized in ultrasonic sensors configured to measure velocity or flow rate of a fluid in a conduit with a diameter of 100 mm or greater. In some instances, same-sized transducers are used across a range of conduit sizes for reasons of practicality and ease of manufacture. For example, flow meter manufacturer may choose to utilize transducers with a diameter of 15 mm for all ultrasonic for flowmeters of 4″ to 24″ nominal diameter.

As a result of the recirculation in the cavity openings, in some attempts to increase an accuracy of measurements from the ultrasonic measurement system, the cavity openings in the wall of the conduit in front of the emission windows of the ultrasonic sensors may be filled with a fill material with a relatively low impedance (e.g., an epoxy, a plastic, a thin barrier, etc.) that is substantially flush with the inside surface of the wall of the conduit to reduce the recirculation in the cavity openings. However, a thickness of the fill material will not be constant across the ultrasonic path in front of the emission window of the ultrasonic sensors, resulting in refraction of the ultrasonic signal emitted by the ultrasonic sensors. Since the fluid flowing through the conduit may have an impedance that varies with temperature, pressure, and composition, it may be impossible to determine material properties of the fill material with an impedance that is substantially similar to the impedance of the fluid, resulting in refraction of the ultrasonic signal at the barrier between the fluid and the fill material. The refraction in the ultrasonic signal emitted by the ultrasonic sensors imposes undesirable limitations and uncertainty in terms of geometry of the ultrasonic path and the resulting accuracy of the flow measurements.

Implementations described herein are related to an ultrasonic measurement system that enables use of cavity openings in a wall of a conduit containing a flow of fluid that are smaller in diameter than the housings and/or the transducers of ultrasonic sensors. The ultrasonic measurement system described herein (e.g., an ultrasonic flow meter system, an ultrasonic velocity meter system, etc.) includes housings with a waveguide array configured to receive the soundwaves from the transducers disposed in the housings at a first surface of the waveguide array with a first cross-sectional area substantially equal to an emission face area of the transducers and output the longitudinal soundwaves into the fluid from a second surface of the waveguide array with a second cross-sectional area that is less than the first cross-sectional area. For example, the waveguide array may be configured to convey the longitudinal soundwaves from the first surface with a first diameter of 25 mm to the second surface with a second diameter of 5 mm, which results in a reduction between the first cross-sectional area of the first surface to the second cross-sectional area of the second surface by a factor of 25. Since the second cross-sectional areas of the second surfaces of the waveguide arrays are smaller than the emission face area of the transducers, the diameter of the cavity opening in the wall of the conduit may have a diameter that is less than the diameter of the housing and/or the transducer while still receiving the longitudinal soundwaves from the second surface of the waveguide array. The reduction in the size of the opening reduces the size of the recirculation zone in the cavity relative to the overall conduit size and increases the accuracy of the ultrasonic measurement system. For example, the size of the cavity may be reduced below a threshold where the problems of non-linearity from the recirculation of the fluid in the cavity may be reduced to a level that is negligible. For example, in some instances, the threshold of the size of the cavities may be where a ratio between a diameter of the conduit and a diameter of the cavity is 15:1 or greater. Additionally, the housings with the waveguide array are configured to receive the soundwaves through the fluid from another of the transducers and convey the soundwaves from the second surface of the waveguide array with the second cross-sectional area to the first surface of the waveguide array with the first cross-sectional area to be provided to the transducer that corresponds with the housing such that the transducers may accurately measure the soundwaves and the ultrasonic measurement system may determine the transit time of the soundwaves between the transducers based on the measurements.

In some instances, the waveguide arrays include a plurality of waveguide elements (e.g., tapered rods, etc.) configured to convey the acoustic signals between the first surfaces of the waveguide arrays and the second surfaces of the waveguide arrays in order to preserve the phase relationship of separate portions of the signal to each other in order to convey a coherent signal. In some instances, each of the waveguide elements are configured such that a lateral dimension of the waveguide elements (e.g., a diameter of the waveguide elements, a width of the waveguide elements, etc.) is small relative to a wavelength of longitudinal soundwaves produced by the transducers. In some instances, each of the waveguide elements in the waveguide array is configured to have a varying cross-sectional area along a length of the waveguide elements. For example, each of the waveguide elements may have a first cross-sectional area proximate the transducer and a second cross-sectional area distal to the transducer that is smaller than the first cross-sectional area.

### Ultrasonic Sensor Systems

### Fluid Conduit

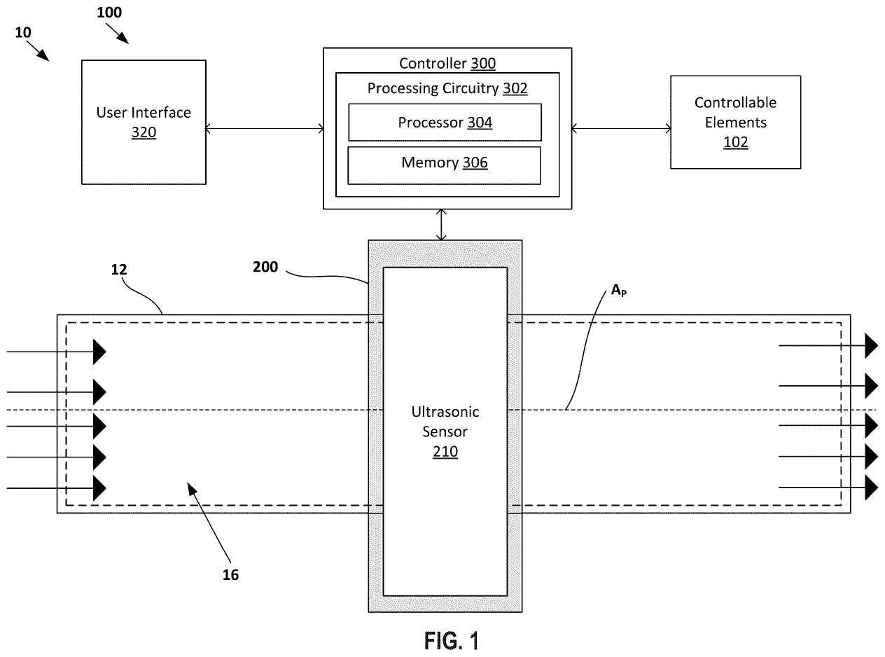

Referring to FIG. 1, a system 10 for monitoring a conduit 12 (e.g., a pipeline, a pipeline for fluid such as gas or liquid or a mixture of the two, a pipeline for a gas such as a compressible gas, natural gas including methane and contaminants, an acid gas such as carbon dioxide and hydrogen sulfide, or a pipeline for liquids such as natural gas, gasoline, aviation fuel, crude oil, distillates, diesel, butane, propane, ethane, etc.) is shown, according to some embodiments. The conduit 12 includes a primary axis A_{P} (e.g., a center axis, etc.) along a length of the conduit 12. The system 10 can be configured to monitor one or more conditions of a fluid 16 (e.g., a hydrocarbon, a natural gas, a gas, a liquid/gas mixture, etc.) that flows or travels within the conduit 12. In some embodiments, the primary axis A_{P} of the conduit 12 is parallel to a direction of flow of the fluid 16 that is flowing through the conduit 12. For example, the primary axis A_{P} may be positioned in a center of the flow of the fluid 16 in the direction parallel to the flow of the fluid 16. The system 10 can include a control system 100 that is configured to receive and use sensor inputs from one or more sensing units 200 that measure one or more conditions or properties of the fluid (e.g., temperature, pressure, dynamic pressure, static pressure, flow rate, fluid permissively, etc.) to determine various properties of the fluid (e.g., velocity, composition, quality of dispersion, etc.) or to adjust the operation of one or more devices of the system 10 (e.g., to affect the fluid 16 within the conduit 12). In some embodiments, the conduit 12 is for a crude oil, natural gas, hydrogen, gasoline, an acid gas (e.g., including a mixture of carbon dioxide and hydrogen sulfide), or other petroleum products including but not limited to mixtures of oil and gas products (e.g., mixtures of hydrocarbons and water, etc.). In other embodiments, the system 10 may be configured to monitor one or more conditions of the fluid 16 in other operations. For example, the system 10 may be configured to monitor one or more conditions of the fluid 16 while the fluid 16 is being stored in a tank, pumped through a pump, or involved in other operations.

The control system 100 also includes the sensing unit 200 (e.g., an ultrasonic sensor system, etc.). that includes one or more sensors. In some embodiments, the control system 100 may include any number of sensing units 200 to measure conditions or properties of the fluid 16 at different locations of the conduit 12. The sensing unit 200 includes an ultrasonic measurement system 210 configured to measure a travel time of ultrasonic signals along an ultrasonic path between a pair of transducers oriented around a periphery of the conduit 12 such that ultrasonic path is through the fluid 16 that flows through the conduit 12. The ultrasonic path between the pair of transducers is orientated at a path angle that is non-normal to a primary axis of the conduit 12 such that the travel time of the ultrasonic signals along the ultrasonic path is sensitive to the flow of the fluid 16 through the conduit 12. For example, a first of the pair of transducers may be positioned upstream of a second of the pair of transducers such that the ultrasonic path between the first of the pair of transducers and the second of the pair of transducers is non-normal to the primary axis of the conduit 12. The control system 100 may receive the measurements of the travel time of the ultrasonic signals from the ultrasonic measurement system 210 and determine a velocity and/or a flow rate of the fluid 16 through the conduit 12 based on the travel times. In other embodiments, the ultrasonic measurement system 210 may be used by other measurement systems. For example, the ultrasonic measurement system 210 may be utilized by a distance ranging measurement system to determine a distance. As another example, the ultrasonic measurement system 210 may be utilized by an anemometer system to determine a wind speed and/or a wind direction.

In some embodiments, the ultrasonic measurement system 210 includes multiple pairs of transducers (e.g., a first pair of transducers, a second pair of transducers, a third pair of transducers, a fourth pair of transducers, etc.), each configured to measure travel times of ultrasonic signals along ultrasonic paths between each of the pairs of transducers through the fluid 16 that flows through the conduit 12. For example, the ultrasonic measurement system 210 may be configured as a four-chord multipath ultrasonic flow meter that includes four pairs of transducers orientated around the periphery of the conduit 12. The ultrasonic measurement system 210 may measure the travel times of the ultrasonic signals along four of the ultrasonic paths between each of the four pairs of transducers. The control system 100 may receive the measurements of the travel times of the ultrasonic signals from the ultrasonic measurement system 210 and determine a velocity and/or a flow rate of the fluid 16 through the conduit 12 based on a computation that utilizes the travel times of the ultrasonic signals between the pairs of transducers.

The control system 100 includes the controller 300 (e.g., a programmable logic controller (PLC), a feedback controller, a processing unit, processing circuitry, etc.) that is configured to obtain sensor data from the sensing unit 200, or from the ultrasonic measurement system 210 of the sensing unit 200. The controller 300 can use the sensor data obtained from the sensing unit 200 to determine one or more properties (e.g., a flow rate, a velocity, a phase, a composition, a fluid permittivity, etc.) of the fluid 16 that flows within the conduit 12, can calibrate the sensing unit 200, and can generate control decisions for one or more controllable elements 102. The controllable elements 102 may be configured to adjust an operation of the conduit 12 (e.g., a shut-off valve or pressure control valve) or to adjust/control one or more properties of the fluid 16 that flows through the conduit 12 (e.g., adjusting operation of a pump or compressor, etc.). In this way, the controller 300 can perform a closed-loop feedback control scheme to adjust operation of the controllable elements 102 based on real-time or current sensor data obtained from the sensing units 200. In some embodiments, temperature, pressure, velocity, flow rate and composition can be controlled by various equipment (e.g., a valve for changing flow composition, heating coil, cooling coil, boiler, heat exchanger, port for inserting or removing material, a compressor or pump for controlling pressure, a mixer for changing homogeneity of the material, etc.). For example, the controller 300 may operate the controllable elements 102 to maintain the fluid 16 at a desired flow rate to control the flow of the fluid 16 due to production requirements (e.g., fluid separators unable to handle a flow rate of the fluid 16 above a certain level, etc.).

### Controller Diagram

Still referring to FIG. 1, the control system 100 includes the sensing units 200, the controller 300 and a user interface 320 (e.g., a device including a display screen, a user input device, etc.). In some embodiments, the controller 300 is configured to obtain sensor inputs from the sensing units 200 including measurements of the travel times of the ultrasonic signals through the fluid 16 between the pairs of transducers from the ultrasonic measurement system 210. In various embodiments, the controller 300 is also configured to obtain additional sensor inputs from the sensing units 200 including the temperature of the fluid 16, the pressure of the fluid 16, and/or the composition of the fluid 16. In various embodiments, the controller 300 is configured to obtain sensor inputs from multiple of the sensing units 200. In various embodiments, the controller 300 is also configured to provide a command to the sensing unit 200 (e.g., to initiate the collection of the sensor inputs, etc.).

In some embodiments, the controller 300 can use the sensor inputs received from the sensing units 200 to determine a velocity or a flow rate of the fluid 16 and/or control operations of or control signals provided to the controllable elements 102 to maintain the fluid 16 within or at a desired velocity, to maintain the fluid 16 within or at a desired flow rate, etc. In some embodiments, the controller 300 can use the sensor inputs received from the sensing units 200 to determine a composition of the fluid 16, a pressure of the fluid 16, etc. The controller 300 can also generate and output display information for the user interface 320 (e.g., an X-Y plot, a table, etc.) so that the user interface 320 can operate to display current conditions of the fluid 16 in the conduit 12 for an operator or a technician. For example, the controller 300 may generate and output display information for the user interface 320 associated with the velocity of the fluid 16 and/or the flow rate of the fluid 16 so that the user interface 320 can operate to display the velocity of the fluid 16 and/or the flow rate of the fluid 16 in the conduit 12.

The controller 300 includes processing circuitry 302 including a processor 304 and memory 306. The processor 304 can be a general purpose or specific purpose processor, an application specific integrated circuit (ASIC), one or more field programmable gate arrays (FPGAs), a group of processing components, or other suitable processing components. The processor 304 may be configured to execute computer code and/or instructions stored in the memory 306 or received from other computer readable media (e.g., CDROM, network storage, a remote server, etc.).

The memory 306 can include one or more devices (e.g., memory units, memory devices, storage devices, etc.) for storing data and/or computer code for completing and/or facilitating the various processes described in the present disclosure. The memory 306 can include random access memory (RAM), read-only memory (ROM), hard drive storage, temporary storage, non-volatile memory, flash memory, optical memory, or any other suitable memory for storing software objects and/or computer instructions. The memory 306 can include database components, object code components, script components, or any other type of information structure for supporting the various activities and information structures described in the present disclosure. The memory 306 can be communicably connected to the processor 304 via the processing circuitry 302 and can include computer code for executing (e.g., by the processor 304) one or more processes described herein.

The memory 306 may include a database that can store properties of the conduit 12, fluid parameters, and/or fluid models that can be used by the controller 300 to determine fluid properties of the fluid 16 based on the sensor data received from the sensing unit 200. For example, the memory 306 may include a database that can store geometric models of the ultrasonic measurement system 210 including the ultrasonic paths between the pairs of transducers that can be used by the controller 300 to determine the velocity and/or the flow rate of the fluid 16 based on the measurements of the travel times of the ultrasonic signals between the pairs of the transducers of the ultrasonic measurement system 210.

In some embodiments, the memory 306 includes geometry of the ultrasonic measurement system 210. For example, the memory 306 may include positional relationships of components of the ultrasonic measurement system 210, thicknesses of components of the ultrasonic measurement system 210, material data relating to materials making up components of the ultrasonic measurement system 210, measured time delays in transducers and/or other calibration values, and/or other information corresponding to the ultrasonic measurement system 210. The controller 300 may utilize the information corresponding to the ultrasonic measurement system 210 to determine fluid properties of the fluid 16.

In some instances, the controller 300 may utilize data from the memory 306 to determine the velocity and/or the flow rate of the fluid 16. For example, the controller 300 may utilize the geometric models of the ultrasonic measurement system 210 and the sensor data received from the ultrasonic measurement system 210 to determine a velocity of the fluid 16 based on the travel time of the ultrasonic signals between the transducers of the ultrasonic measurement system 210 and distances between the transducers based on the geometric model of the ultrasonic measurement system 210. In some embodiments, the memory 306 includes a series of lookup tables that can be used by the controller 300 to determine the velocity and/or the flow rate of the fluid 16.

In some embodiments, the controller 300 is configured to use the velocity and/or the flow rate of the fluid 16 as determined based on the sensor data from the sensing unit 200 to determine control operations for the controllable elements 102 in order to control the flow of the fluid 16 through the conduit 12. For example, the controller 300 may determine control operations to maintain the flow of the fluid 16 through the conduit 12 (e.g., the controllable elements 102 include a valve and the control operation is to open or close the valve, etc.).

Referring still to FIG. 1, the controller 300 is configured to generate display data and provide the display data to the user interface 320, according to some embodiments. The user interface 320 may be a remote device, a user device, a display screen, etc., according to some embodiments. In some embodiments, the display data generated by the controller 300 includes elements corresponding to measurements of the sensors of the sensing unit 200. For example, the display data generated by the controller 300 may include the velocity of the fluid flowing through the conduit 12 or the flow rate of the fluid flowing through the conduit 12. The display data can also include any of the sensor data obtained by the sensing unit 200, according to some embodiments. In some embodiments, the display data also includes the control decisions made by the controller 300.

In some embodiments, the controller 300 is configured to provide actionable elements (e.g., buttons, sliders, etc.) to the user interface 320 and receive a selection of the actionable elements from the user interface 320. For example, the display data may include a button corresponding to one of the control decisions available to the controller 300 and the controller 300 may be allowed to make the one of the control decisions in response to the controller 300 receiving an indication of a selection of the button from the user interface 320.

### Ultrasonic Sensor System Implementation

Descriptions in this section describe aspects that are common to prior art transducer and transducer housing arrangements as well as embodiments of the current disclosure. These will be highlighted and will be clear to those skilled in the art.

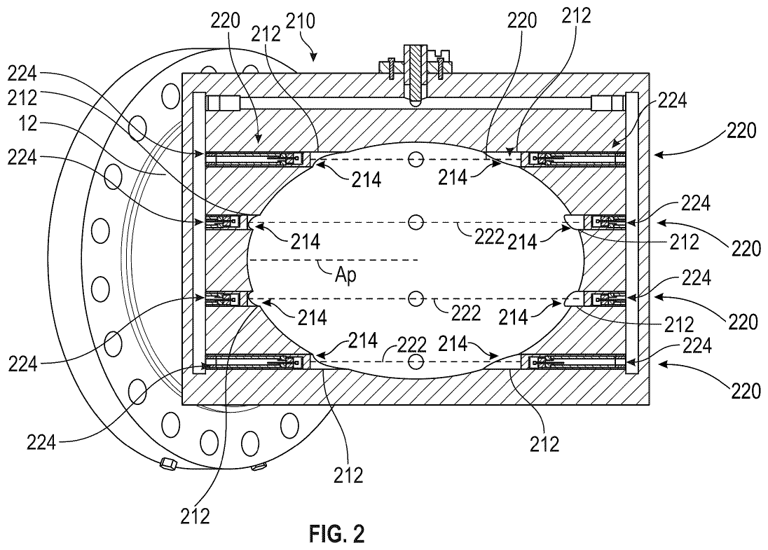

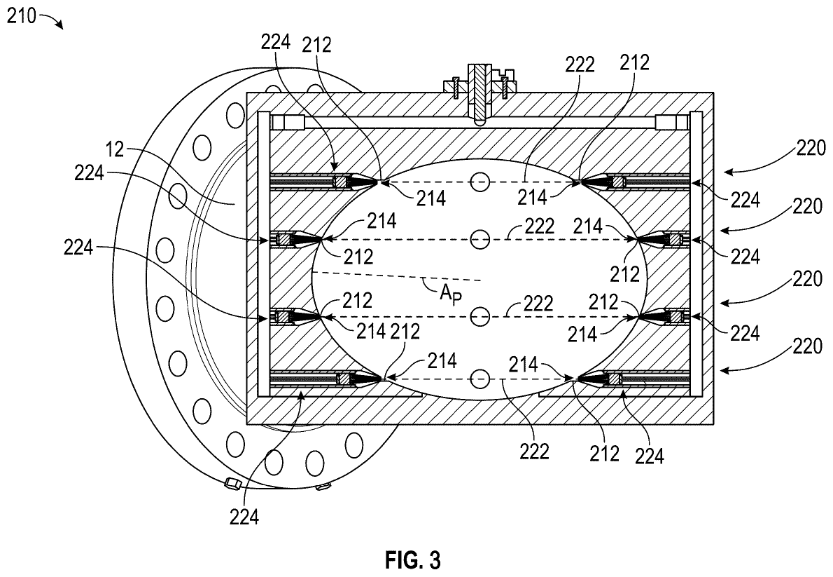

Referring now to FIGS. 2 and 3, the ultrasonic measurement system 210 for monitoring the conduit 12 is shown, according to some embodiments. The ultrasonic measurement system 210 may be configured to perform a method of measuring a property of the fluid 16 flowing in the conduit 12. The ultrasonic measurement system 210 includes a plurality of ultrasonic sensor pairs 220. Each of the ultrasonic sensor pairs 220 is configured to measure a travel time of ultrasonic soundwaves across the flow of the fluid 16 in the conduit 12 along an ultrasonic path 222. In other embodiments, the ultrasonic measurement system 210 includes one of the ultrasonic sensor pairs 220 configured to measure a travel time of ultrasonic soundwaves along one of the ultrasonic paths 222.

In some embodiments, each of the ultrasonic paths 222 are orientated at an angle that is non-normal (e.g., an angle other than 90 degrees, an angle less than 90 degrees, an angle greater than 90 degrees, etc.) to the primary axis A_{P} of the conduit 12 such that ultrasonic signals along the path are not in a direction normal to the direction of flow of the fluid 16 flowing through the conduit 12. In some embodiments, each of the ultrasonic paths 222 are oriented parallel to the primary axis A_{P} of the conduit 12.

Each of the ultrasonic sensor pairs 220 includes a pair of ultrasonic sensors 224 positioned on opposite sides of the fluid 16 (e.g., opposite sides of the conduit 12, etc.) and configured to transmit and receive the ultrasonic soundwaves moving along the ultrasonic paths 222 across the fluid 16. For example, one of the ultrasonic sensor pairs 220 may include a first of the ultrasonic sensors 224 positioned on a first side of the fluid 16 (e.g., a first side of the conduit 12, etc.) and a second of the ultrasonic sensors 224 positioned on a second side of the fluid 16 opposite the first side of the fluid 16 (e.g., a second side of the conduit 12 opposite the first side of the conduit 12, etc.), with the ultrasonic path 222 for the one of the ultrasonic sensor pairs 220 extending between the first of the ultrasonic sensors 224 and the second of the ultrasonic sensors 224. In some embodiments, front faces of each of the ultrasonic sensors 224 of each of the ultrasonic sensor pairs 220 are parallel such that the ultrasonic soundwaves emitted by the each of the ultrasonic sensors 224 are emitted substantially along the ultrasonic paths 222 between the ultrasonic sensors 224. In other embodiments, the ultrasonic measurement system 210 includes an ultrasonic transducer positioned on a first side of the fluid 16 configured to transmit the ultrasonic soundwaves moving along the ultrasonic paths 222 across the fluid 16 and an ultrasonic receiver positioned on an opposing second side of the fluid 16 configured to receive the ultrasonic soundwaves from the ultrasonic sensor 224. The ultrasonic transducer of the ultrasonic measurement system 210 may be one of the ultrasonic sensors 224.

As shown in FIGS. 2 and 3, as a result of the front faces of each of the ultrasonic sensors 224 of each of the ultrasonic sensor pairs 220 being parallel and the ultrasonic path 222 between the ultrasonic sensors 224 of each of the ultrasonic sensor pairs 220 being non-normal to the primary axis A_{P} of the conduit 12, each of the ultrasonic sensors 224 are at least partially disposed in a cavity 212 (e.g., an opening, a semi-cylindrical cavity, a recess, etc.) defined by a wall of the conduit 12, according to some embodiments. For example, a first of the ultrasonic sensors 224 may be at least partially disposed in a first cavity defined by the wall of the conduit 12 and a second of the ultrasonic sensors 224 included in the ultrasonic sensor pair 220 of the first of the ultrasonic sensors 224 may be at least partially disposed in a second cavity defined by the wall of the conduit 12. As shown in FIGS. 2 and 3, a size (e.g., a cross-sectional area, a width, etc.) of the cavities 212 depends on a configuration of the ultrasonic sensors 224. For example, a first configuration of the ultrasonic sensors 224 may be associated with a first size of the cavities 212 and a second configuration of the ultrasonic sensors 224 may be associated with a second size of the cavities 212.

In some embodiments, each of the cavities 212 is configured to receive one of the ultrasonic sensors 224. For example, each of the cavities 212 may define threads configured to engage threads of the ultrasonic sensors 224 to allow for the ultrasonic sensors 224 to be coupled to the wall of the conduit 12. In some embodiments, each of the cavities 212 also defines a cavity opening 214 positioned in front of the corresponding of the ultrasonic sensors 224 to allow for the front faces of each of the ultrasonic sensors 224 of each of the ultrasonic sensor pairs 220 to be parallel and the ultrasonic path 222 between the ultrasonic sensors 224 of each of the ultrasonic sensor pairs 220 to be non-normal to the primary axis A_{P} of the conduit 12 without the ultrasonic path 222 traveling through the wall of the conduit 12, which may interfere with the ultrasonic soundwaves between the ultrasonic sensors 224. The cavity opening 214 of each of the cavities 212 may be positioned in front of each of the ultrasonic sensors 224 to allow for the ultrasonic signals between the ultrasonic sensors 224 to follow the ultrasonic paths 222 without passing through the wall of the conduit 12. In other embodiments, the cavities 212 do not define the cavity openings 214 positioned in front of the corresponding of the ultrasonic sensors and each of the ultrasonic sensors 224 extend past an inside surface of the wall of the conduit 12 into the flow of the fluid 16 to allow for the ultrasonic signals between the ultrasonic sensors 224 to follow the ultrasonic paths 222 without passing through the wall of the conduit 12.

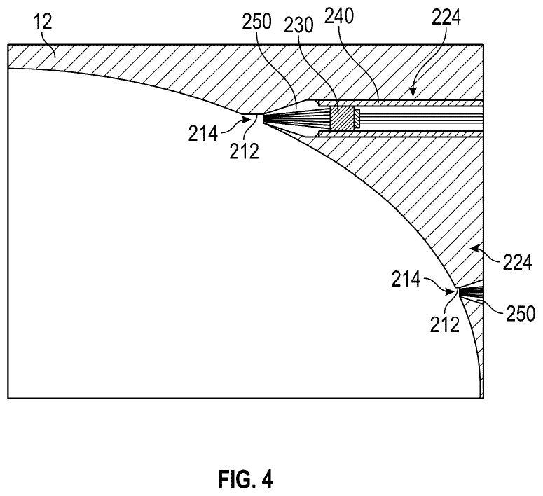

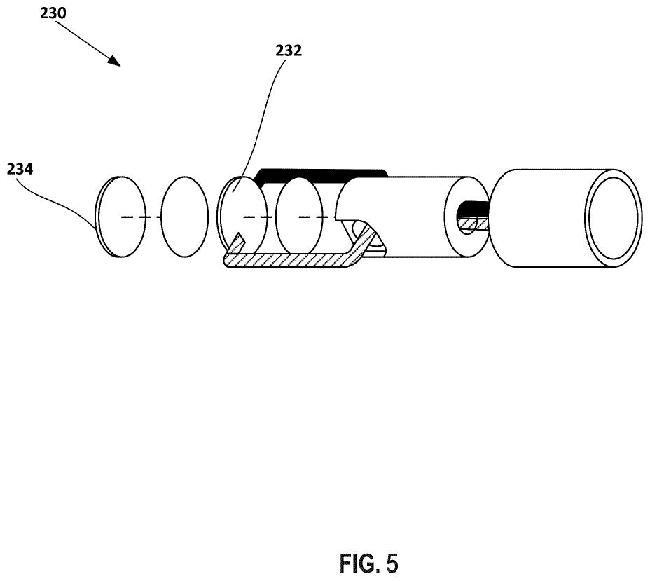

As shown in FIGS. 4 and 6-8, each of the ultrasonic sensors 224 includes a transducer 230, a housing 240, and an ultrasonic window 250. For example, a first of the ultrasonic sensors 224 may include a first transducer, a first housing, and a first ultrasonic window and a second of the ultrasonic sensors 224 included in the ultrasonic sensor pair 220 of the first of the ultrasonic sensors 224 may include a second transducer, a second housing, and a second ultrasonic window. In some embodiments, the transducer 230 is configured to (i) receive electrical energy from the controller 300 and generate (e.g., provide, emit, etc.) ultrasonic soundwaves based on the electrical energy received from the controller 300 and (ii) receive ultrasonic soundwaves and generate and provide electrical energy to the controller 300 based on the ultrasonic soundwaves. According to the example embodiment shown in FIG. 5, each of the transducers 230 include a piezoceramic active element 232 (i) configured to generate ultrasonic soundwaves when an electric field is applied to the piezoceramic active element 232 and (ii) configured to generate an electric field when the piezoceramic active element 232 receives an ultrasonic soundwave. For example, the controller 300 may send a signal to the transducer 230 that results in an electric field being applied to the piezoceramic active element 232, resulting in the piezoceramic active element 232 generating an ultrasonic soundwave. As another example, the piezoceramic active element 232 may receive an ultrasonic soundwave, resulting in the piezoceramic active element 232 generating an electric field and the transducer 230 providing a signal to the controller 300 corresponding to the electric field. In some instances, the transducers 230 include disks of piezoceramic material with a diameter in a range of approximately 10 mm to 25 mm. In other embodiments, each of the transducers 230 may be configured as an alternate type of transducer (e.g., electrodynamic transducers, magnetostrictive transducers, capacitive transducers, electrostatic transducers, etc.) configured to generate and receive ultrasonic soundwaves and couple those to the waveguide array. In some instances, the transducer 230 is configured to emit ultrasonic soundwaves within a frequency range of interest (e.g., within a frequency, at a frequency, etc.). For example, the frequency of interest may be a high frequency selected based on the fluid 16 flowing through the conduit 12 (e.g., 1 MHz, etc.). In some instances, the transducers 230 may be configured to provide and receive the ultrasonic sound waves through an emission face of the transducers 230.

As shown in FIGS. 5, 7, 10, 11, and 17 the transducer 230 includes an interface 234. The transducer 230 is configured to emit the ultrasonic soundwaves produced by the transducer 230 through the interface 234 and receive the ultrasonic soundwaves produced by the transducer 230 of the other of the ultrasonic sensors 224 of the ultrasonic sensor pair 220 through the interface 234. The interface 234 may have an interface area where the ultrasonic soundwaves are emitted and/or received.

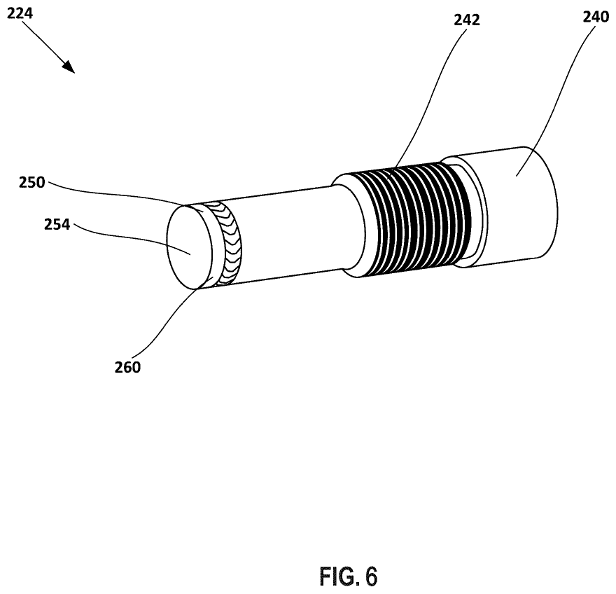

As shown in FIGS. 4 and 6-8, the housing 240 is configured to receive the transducer 230. For example, the transducer 230 may be disposed inside of the housing 240 and the housing 240 may be configured to protect the transducer 230. In some embodiments, the housing 240 is configured to couple the ultrasonic sensor 224 to the cavity 212 defined by the wall of the conduit 12. In the example embodiment shown in FIG. 6, the housing 240 defines threads on an outside surface of the housing 240 configured to engage threads defined by the cavity 212 to couple the ultrasonic sensor 224 to the cavity 212. In various embodiments, the housing 240 is configured to seal against the cavity 212 to prevent the fluid 16 flowing inside the conduit 12 from leaking out of the conduit 12 between the cavity 212 and the housing 240. For example, the housing threads 242 may seal against the threads defined by the cavity 212 to prevent the fluid 16 from leaking out of the conduit 12 between the cavity 212 and the housing 240.

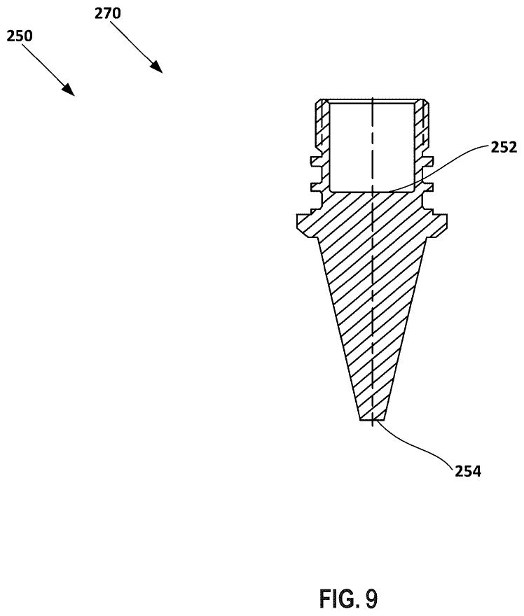

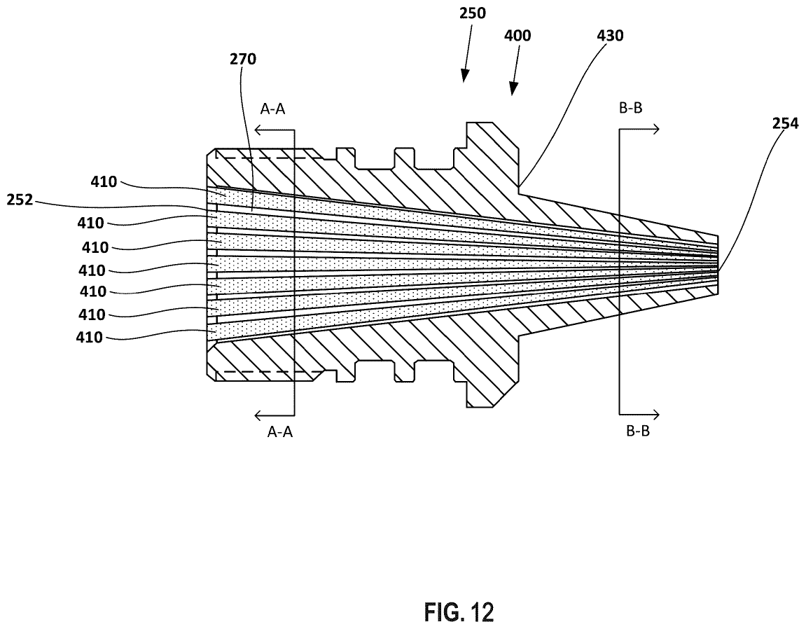

As shown in FIGS. 4, 6-12, and 17 the ultrasonic window 250 is coupled to the housing 240 and is configured to (i) receive the ultrasonic soundwaves produced by the transducer 230 and provide the ultrasonic soundwaves to the fluid 16 flowing through the conduit 12 and (ii) receive ultrasonic soundwaves from the fluid 16 flowing through the conduit 12 (e.g., ultrasonic soundwaves produced by another of the transducers 230 of the ultrasonic measurement system 210, etc.) and provide the ultrasonic soundwaves to the transducer 230. In some embodiments, the ultrasonic window 250 is releasably coupled to the housing 240. For example, the ultrasonic window 250 may define threads configured to engage threads of the housing 240 to couple the ultrasonic window 250 to the housing 240. In other embodiments, the ultrasonic window 250 may be coupled to the housing 240 using other means (e.g., welding, soldering, adhesives, etc.).

As shown in FIGS. 6-12, and 17, the ultrasonic window 250 includes an inward face 252 (e.g., a reception face, a proximal face, etc.) configured to receive the ultrasonic soundwaves emitted by the transducer 230 and provide the ultrasonic soundwaves received by the ultrasonic window 250 from the fluid 16. In some instances, the inward face 252 contacts (e.g., touches, abuts against, etc.) the transducer 230 to receive the ultrasonic soundwaves emitted by the transducer 230 and provide the ultrasonic soundwaves received by the ultrasonic window 250 from the fluid 16. In some instances, the inward face 252 is coupled to the transducer 230. For example, the inward face 252 may be adhered to the transducer 230 by an adhesive to prevent separation of the inward face 252 of the ultrasonic window 250 from the transducer 230 such that the ultrasonic soundwaves can be successfully transmitted between the ultrasonic window 250 and the transducer 230. In other embodiments, the inward face 252 is separated from the transducer 230 and receives the ultrasonic soundwaves emitted by the transducer 230 and provides the ultrasonic soundwaves received by the ultrasonic window 250 from the fluid 16 through a medium positioned between the inward face 252 and the transducer 230 (e.g., a spacer, an ultrasonic soundwave conductor, a solid coupling material, a coupling fluid, etc.).

In some instances, an inward area of the inward face 252 of the ultrasonic window 250 is greater than or equal to the interface area of the interface 234 of the transducer 230 such that the inward face 252 may receive all of the ultrasonic soundwaves emitted through the interface 234 of the transducer 230. In other embodiments, the inward area of the inward face 252 of the ultrasonic window 250 is less than or equal to the interface area of the interface 234 of the transducer 230.

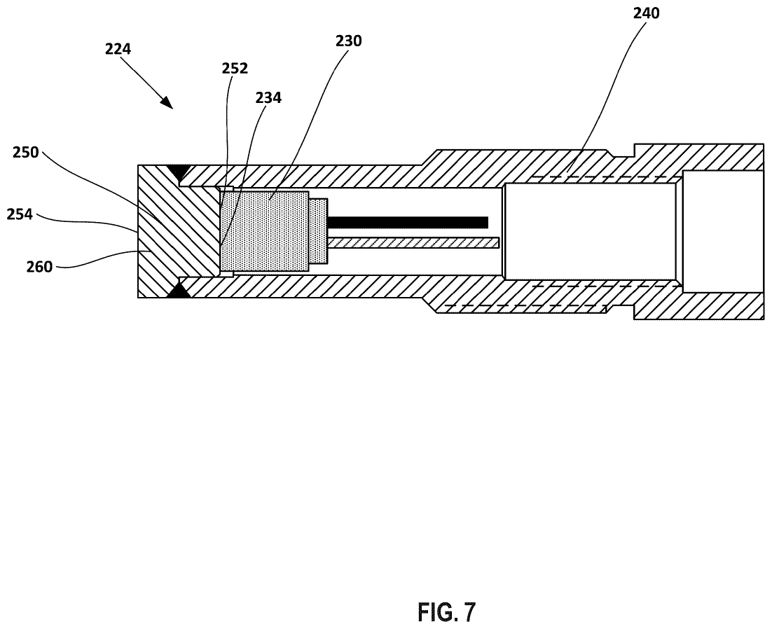

As shown in FIGS. 7-12, and 17, the ultrasonic window 250 includes an outward face 254 (e.g., an emission face, a distal face, etc.) configured to provide (e.g., emit, etc.) the ultrasonic soundwaves received from the transducer 230 into the fluid 16 and receive the ultrasonic soundwaves from the fluid 16 (e.g., emitted by the other of the ultrasonic sensors 224 included in the ultrasonic sensor pair 220 of the ultrasonic sensor 224 of the transducer 230, etc.). In some instances, the outward face 254 contacts (e.g., touches, etc.) the fluid 16 flowing through the conduit 12. For example, the outward face 254 may be disposed in the cavity opening 214 and may contact the fluid 16 positioned within the cavity opening 214. As another example, when the ultrasonic window 250 extends beyond the inner surface of the wall of the conduit 12, the outward face 254 may be disposed in the conduit 12 and may contact the fluid 16 positioned within the conduit 12. In various embodiments, the outward face 254 may include a coating configured to resist the fluid 16 (e.g., resist corrosion by the fluid 16, resist erosion by the fluid 16, etc.).

### Planar Window

As shown in FIGS. 6, 7, and 18, prior art embodiments of the ultrasonic sensor 224 include the ultrasonic window 250 configured as a planar window 260 (e.g., a planar configuration of the ultrasonic window 250. For the planar window 260 configuration of the ultrasonic window 250, the outward face 254 of the ultrasonic window 250 has an outward area (e.g., an emission area, a first cross-sectional area, etc.) that is greater than or equal to an inward area (e.g., a reception area, a second cross-sectional area, etc.) of the inward face 252 of the ultrasonic window 250. As a result, each of the ultrasonic soundwaves received by the inward face 252 with a first cross-sectional area are conveyed through the ultrasonic window 250 configured as the planar window 260 and are emitted by the outward face 254 with a second cross-sectional area that is greater than or equal to the first cross-sectional area. Additionally, since a majority of the ultrasonic soundwaves traveling through the planar window 260 are substantially perpendicular to the inward face 252 and the outward face 254, a path of the majority of the ultrasonic soundwaves through the planar window 260 has an equal length and the majority of the ultrasonic soundwaves are emitted by the outward face 254 in phase with each other, resulting in coherent ultrasonic soundwaves emitted by the outward face 254. The coherent ultrasonic soundwaves emitted by the outward face 254 of a first of the ultrasonic sensors 224 may be clear and identifiable by a second of the ultrasonic sensors 224 included in the ultrasonic sensor pair 220 of the first of the ultrasonic sensors 224 such that the ultrasonic measurement system 210 may determine the travel time of the ultrasonic soundwaves between the ultrasonic sensor pair 220.

However, as shown in FIG. 2, since the outward face 254 of the planar window 260 has the outward area that is greater or equal to the inward area of the inward face 252 of the planar window 260 and the cavity 212 is sized to receive the planar window 260, the size of the inward face 252 of the planar window 260 will determine the size of the cavity 212. For example, a width of the cavity 212 may be greater than a diameter of the inward face 252 of the planar window 260 such that the cavity 212 may receive the outward face 254 of the planar window 260. The size of the cavity 212 affects an accuracy of the velocity and/or the flow rate of the fluid 16 determined by the controller 300 based on the sensor data from the sensing unit 200 due to recirculation of the fluid 16 within the cavity opening 214 contributing to the transit time of the ultrasonic signals between the transducers 230 of the ultrasonic measurement system 210. For example, when the cavity 212 has a first width, recirculation of the fluid in the cavity 212 may result in the controller 300 determining a velocity of the fluid 16 that has a lower accuracy than when the cavity 212 has a second width that is less than the first width due to recirculation within the cavity 212 with the first width contributing more to transit times of ultrasonic signals between the transducers 230 than recirculation within the cavity 212 with the second width. As a result, when the sensing unit 200 includes the ultrasonic sensors 224 that include the ultrasonic window 250 configured as the planar window 260, the velocity and/or the flow rate of the fluid 16 determined by the controller 300 based on the sensor data from the sensing unit 200 will be less accurate than when the sensing unit 200 includes the ultrasonic sensors 224 that include ultrasonic windows 250 with smaller of the outward face 254 than the planar window 260.

### Conical Monolithic Window

The preceding example of the ultrasonic window 250 configured as the planar window 260 shows how the ultrasonic window 250 can maintain a coherent signal but imposes undesirable limitations on the size of the cavity opening 214 in front of the outward face 254 of the ultrasonic window 250. It may appear that all that is necessary is to taper the ultrasonic window 250 such that the outward face 254 has a smaller area than the inward face 252. The discussion that follows shows why such an approach is not as effective when compared with the current disclosure.

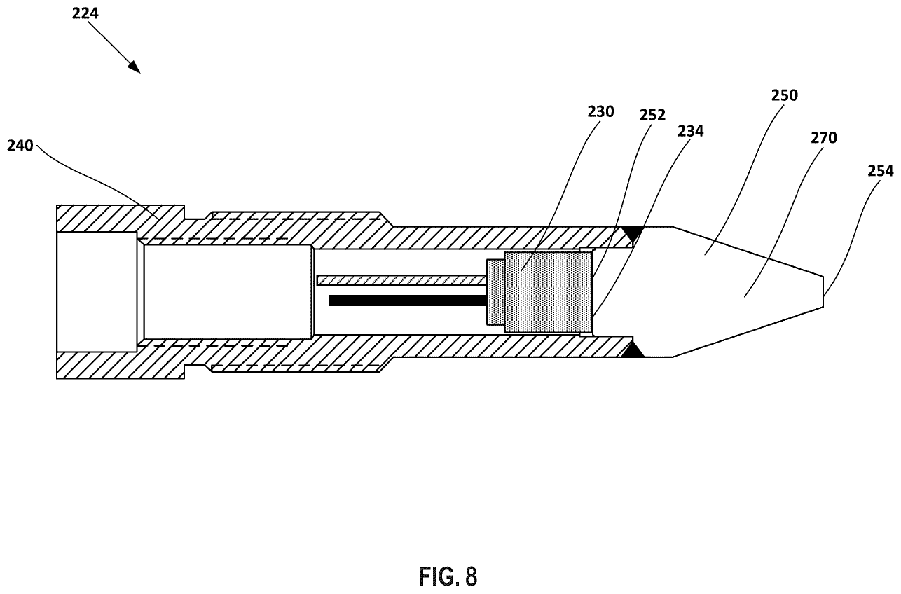

As shown in FIGS. 8-10 and 19, an example of the ultrasonic sensors 224 include the ultrasonic window 250 configured as a monolithic conical window 270 (e.g., a conical ultrasonic window, a conical window formed from a single element, etc.). For the monolithic conical window 270 configuration of the ultrasonic window 250, the outward area of the outward face 254 of the ultrasonic window 250 is less than the inward area of the inward face 252 of the ultrasonic window 250. Since the outward area of the outward face 254 is less than the inward area of the inward face 252 when the ultrasonic window 250 is configured as the monolithic conical window 270, a size of the cavity opening 214 positioned in front of the outward face 254 may be smaller than when the ultrasonic sensors 224 includes the ultrasonic window 250 configured as the planar window 260. As discussed above, the size of the cavity 212 affects the accuracy of the velocity and/or the flow rate of the fluid 16 determined by the controller 300 based on the sensor data from the sensing unit 200 due to recirculation of the fluid 16 within the cavity opening 214 contributing to the transit time of the ultrasonic signals between the transducers 230 of the ultrasonic measurement system 210. For example, when the ultrasonic sensors 224 includes the ultrasonic window 250 configured as the planar window 260, the cavity 212 may have a first width greater than the inward face 252 due to the outward face 254 having a first diameter greater than or equal to that of the inward face 252. When the ultrasonic sensors 224 includes the ultrasonic window 250 configured as the monolithic conical window 270, the cavity 212 may have a second width less than the first width due to the outward face 254 having a second diameter less than that of the inward face 252. As a result, when the sensing unit 200 includes the ultrasonic sensors 224 that include the ultrasonic window 250 configured as the monolithic conical window 270, the velocity and/or the flow rate of the fluid 16 determined by the controller 300 based on the sensor data from the sensing unit 200 would be less affected by recirculation in the cavity 212 than when the ultrasonic sensors 224 include the ultrasonic window 250 configured as the planar window 260.

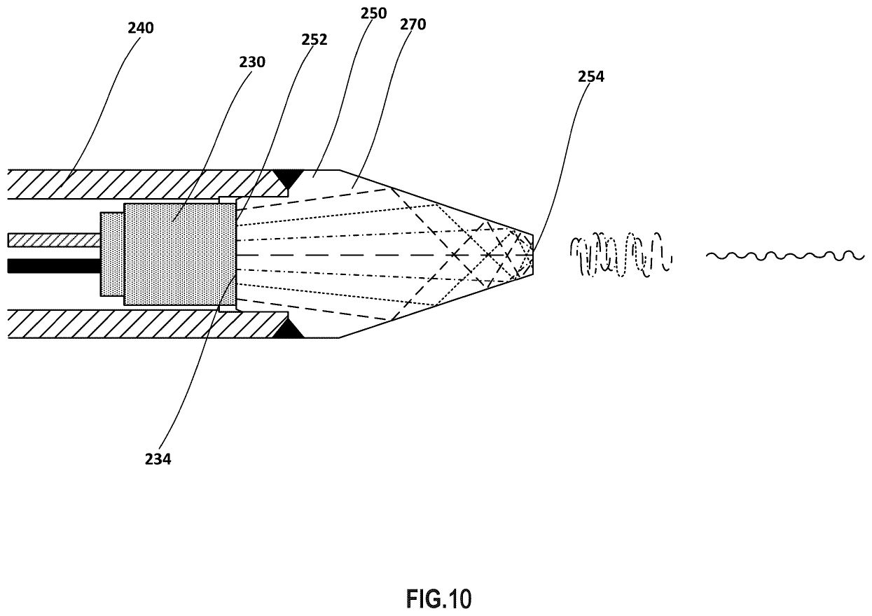

However, a width of the monolithic conical window 270 may be greater than a wavelength of the ultrasonic soundwaves emitted by the transducer 230. As a result, as shown in FIG. 10, as the ultrasonic soundwaves are conveyed through the ultrasonic window 250 configured as the monolithic conical window 270, the ultrasonic soundwaves may disperse and reflect off of the outside surface of the monolithic conical window 270 while traveling from the inward face 252 to the outward face 254. As a result of the reflections of the ultrasonic soundwaves, a length of the path taken by each of the ultrasonic soundwaves through the monolithic conical window 270 may be different from each other and some of the ultrasonic soundwaves may be emitted by the outward face 254 out of phase with each other, resulting in destructive interference and incoherent ultrasonic soundwaves emitted by the outward face 254. The incoherent ultrasonic soundwaves emitted by the outward face 254 of a first of the ultrasonic sensors 224 may be unclear or unidentifiable in the signal processing step when received by a second of the ultrasonic sensors 224 included in the ultrasonic sensor pair 220 of the first of the ultrasonic sensors 224 such that the ultrasonic measurement system 210 may not be able to accurately determine the travel time of the ultrasonic soundwaves between the ultrasonic sensor pair 220.

### Waveguide Array

The preceding discussion shows how the ultrasonic sensors 224 including the ultrasonic window 250 configured as the planar window 260 can maintain coherent signal transmission into the fluid 216, but necessitates that the cavity 212 is wide enough that the transmission of the ultrasonic signals from the outward face 254 into the fluid 16 are not impeded. The preceding discussion has also shown that tapering the ultrasonic window 250 as the monolithic conical window 270 without due consideration of the acoustic interaction of the ultrasonic signal and the ultrasonic window 250 results in ultrasonic signals that have undesirable characteristics for accurate transit time measurement. The following discussion explains how the current disclosure herein combines the desirable characteristics of a smaller outward transmitting surface combined with coherent signal transmission.

As shown in FIGS. 3, 4, 11-12, 17, and 20 the ultrasonic window 250 of the ultrasonic sensor 224 is configured as a waveguide array 400. For example, a first of the ultrasonic sensors 224 may include a first of the waveguide arrays 400 and a second of the ultrasonic sensors 224 included in the ultrasonic sensor pair 220 of the first of the ultrasonic sensors 224 may include a second of the waveguide arrays 400. As another example, when the ultrasonic measurement system 210 includes a single of the ultrasonic sensors 224, the ultrasonic sensors 224 may include one of the waveguide arrays 400 and an ultrasonic receiver may receive ultrasonic signals transmitted from the one of the waveguide arrays 400. For the waveguide array 400 configuration of the ultrasonic window 250, the outward area of the outward face 254 of the ultrasonic window 250 is less than the inward area of the inward face 252 of the ultrasonic window 250. Since the outward area of the outward face 254 is less than the inward area of the inward face 252 when the ultrasonic window 250 is configured as the waveguide array 400, a size of the cavity opening 214 positioned in front of the outward face 254 may be smaller than when the ultrasonic sensors 224 includes the ultrasonic window 250 configured as the planar window 260. As discussed above, the size of the cavity 212 affects the accuracy of the velocity and/or the flow rate of the fluid 16 determined by the controller 300 based on the sensor data from the sensing unit 200 due to recirculation of the fluid 16 within the cavity opening 214 contributing to the transit time of the ultrasonic signals between the transducers 230 of the ultrasonic measurement system 210. As a result, when the sensing unit 200 includes the ultrasonic sensors 224 that include the ultrasonic window 250 configured as the waveguide array 400, the velocity and/or the flow rate of the fluid 16 determined by the controller 300 based on the sensor data from the sensing unit 200 would be less affected by recirculation in the cavity 212 than when the ultrasonic sensors 224 include the ultrasonic window 250 configured as the planar window 260.

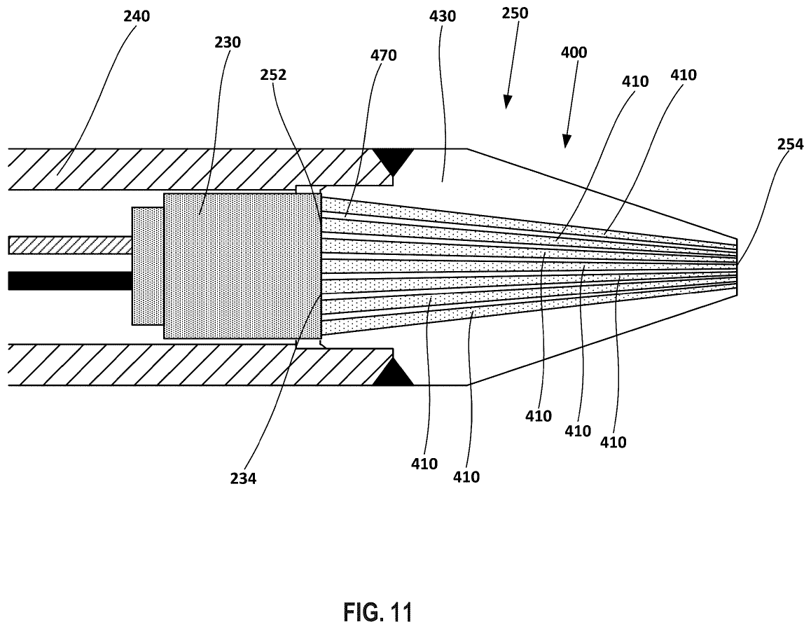

As shown in FIGS. 11-14 and 17, the waveguide array 400 includes a plurality of waveguide elements 410 extending from the inward face 252 of the ultrasonic window 250 to the outward face 254 of the ultrasonic window 250 (e.g., a first waveguide array includes a plurality of first waveguide elements, a second waveguide array include a plurality of second waveguide elements, etc.). Each of the waveguide elements 410 defines a proximal end 412 positioned proximate the inward face 252 of the ultrasonic window 250 and configured to receive the ultrasonic soundwaves produced by the transducer 230 and a distal end 414 opposing the proximal end 412. The distal ends 414 of the waveguide elements 410 are configured to provide the ultrasonic soundwaves received by the proximal end 412 of the waveguide elements 410 into the fluid 16. In some instances, the distal ends 414 of the waveguide elements 410 of a first of the ultrasonic sensors 224 are configured to receive the ultrasonic soundwaves from a second of the ultrasonic sensors 224 included in the ultrasonic sensor pair 220 of the first of the ultrasonic sensors 224 through the fluid 16 and the proximal ends 412 of the waveguide elements 410 are configured to provide the ultrasonic soundwaves received by the distal end 414 to the transducer 230 such that the ultrasonic measurement system 210 may determine the travel time of the ultrasonic soundwaves between the ultrasonic sensor pair 220.

In some instances, each of the waveguide elements 410 may contact other of the waveguide elements 410. For example, a first of the waveguide elements 410 may contact the other of the waveguide elements 410 proximate the first of the waveguide elements 410. The shape of the waveguide elements 410 and limited contact between the waveguide elements 410 may serve as an adequate acoustic discontinuity between the waveguide elements 410 such that the ultrasonic soundwaves travelling (e.g., propagating, etc.) through the waveguide elements 410 do not transfer between the waveguide elements 410 and the coherence of the ultrasonic soundwaves are maintained through the waveguide array 400. In other instances, each of the waveguide elements 410 are separated and do not directly contact any other of the waveguide elements 410.

In some instances, each of the proximal ends 412 of the waveguide elements 410 of the waveguide array 400 are substantially flush. For example, the proximal ends 412 of the waveguide elements 410 may be ground down such that the proximal ends 412 are substantially flush in order to interface with (e.g., contact, couple to, etc.) the emission face of the transducer 230. In some instances, each of the distal ends 414 of the waveguide elements 410 of the waveguide array 400 are substantially flush. For example, the distal ends 414 of the waveguide elements 410 may be ground down such that the proximal ends are substantially flush.

In some instances, each of the proximal ends 412 of the waveguide elements 410 are coupled (e.g., welded, soldered, adhered, fused, etc.) to the proximal ends 412 of the waveguide elements 410 proximate (e.g., next to, surrounding, etc.) each other. For example, the proximal end 412 of a first of the waveguide elements 410 may be coupled to each of the proximal ends 412 of the waveguide elements 410 adjacent to the first of the waveguide elements 410. As another example, the proximal ends 412 of the waveguide elements 410 may be joined together via a welding process such as electron beam welding. In some instances, coupling the proximal ends 412 of the waveguide elements 410 includes filling openings between the proximal ends 412 of the waveguide elements 410 with a coupling material (e.g., steel, lead, etc.) such that the inward face 252 of the ultrasonic window 250 configured as the waveguide array 400 is a continuous surface (e.g., unbroken, without the openings between the proximal ends 412 of the waveguide elements 410, a substantially continuous surface, etc.). For example, by coupling the proximal ends 412 of the waveguide elements 410, the inward face 252 may be a solid face configured to interface with the transducer 230 and receive the ultrasonic soundwaves from a majority of the emission face of the transducer 230. In some instances, the proximal ends 412 of the waveguide elements 410 and the coupling material coupling the proximal ends 412 of the waveguide elements 410 are substantially flush. For example, after the coupling material couples the proximal ends 412 of the waveguide elements 410, the proximal ends 412 of the waveguide elements 410 and the coupling material coupling the proximal ends 412 of the waveguide elements 410 may be ground down such that the proximal ends 412 and the coupling material are substantially flush in order to interface with the emission face of the transducer 230. In other instances, the waveguide elements 410 are coupled with non-planar transducer elements, such as a curved elements.

In some instances, each of the distal ends 414 of the waveguide elements 410 are coupled to the distal ends 414 of the waveguide elements 410 proximate each other. For example, the distal ends 414 of a first of the waveguide elements 410 may be coupled to each of the distal ends 414 of the waveguide elements 410 next to the first of the waveguide elements 410. For example, distal end 414 of a first of the waveguide elements 410 may be coupled to each of the distal ends of the waveguide elements 410 adjacent to the first of the waveguide elements 410. As another example, the distal ends 414 of the waveguide elements 410 may be joined together via a welding process such as electron beam welding. In some instances, coupling the distal ends 414 of the waveguide elements 410 includes filling openings between the distal ends 414 of the waveguide elements 410 with the coupling material such that the outward face 254 of the ultrasonic window 250 configured as the waveguide array 400 is a continuous surface. For example, by coupling the distal ends 414 of the waveguide array 400, the outward face 254 may be a solid face configured to interface with the fluid 16 and receive ultrasonic soundwaves from and emit ultrasonic soundwaves into the fluid 16. Additionally, when the outward face 254 is the solid face, the fluid 16 is prevented from entering the waveguide array 400. When the inward face 252 and the outward face 254 are solid faces, a portion of the waveguide elements 410 may be positioned (e.g., encapsulated, etc.) between the inward face 252, the outward face 254, and the waveguide housing 430. In some instances, the distal ends 414 of the waveguide elements 410 and the coupling material coupling the distal ends 414 of the waveguide elements 410 are substantially flush. For example, after the coupling material couples the distal ends 414 of the waveguide elements 410, the distal ends 414 of the waveguide elements 410 and the coupling material coupling the distal ends 414 of the waveguide elements 410 may be ground down such that the distal ends 414 and the coupling material are substantially flush such that the emission face of the waveguide array 400 (e.g., the outward face 254, etc.) is smooth and has a controlled effect on the direction of the ultrasonic soundwaves emitted by the waveguide array 400.

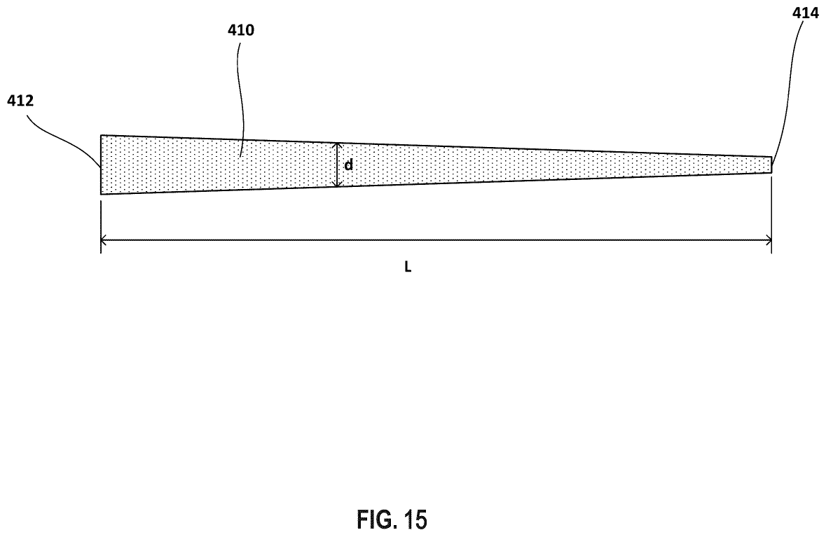

As shown in FIG. 15, each of the waveguide elements 410 defines a cross-sectional width d that varies along a length of the waveguide elements 410. The cross-sectional width d of the waveguide elements 410 is largest at the proximal ends 412 of the waveguide elements 410 and smallest at the distal ends 414 of the waveguide elements 410. The cross-sectional width d of the waveguide elements 410 is less than the wavelength of the ultrasonic soundwaves at the frequency of interest produced by the transducer 230. For example, if the ultrasonic soundwaves have a wavelength of 0.4 mm, then the cross-sectional width d of the waveguide elements 410 is less than 0.4 mm along the length of the waveguide elements 410. Since the cross-sectional width d of the waveguide elements 410 varies along the length of the waveguide elements 410, a first cross-sectional area at the proximal end 412 of each of the waveguide elements 410 (e.g., a proximal area, etc.) is greater than a second cross-sectional area at the distal end 414 of each of the waveguide elements 410 (e.g., a distal area, etc.). Additionally, a first sum of each of the first cross-sectional areas of the waveguide elements 410 of the waveguide array 400 at the proximal end 412 of the waveguide elements 410 (e.g., a sum of the proximal areas, a proximal sum of the proximal areas, etc.) is greater than a second sum of each of the second cross-sectional areas of the waveguide elements 410 of the waveguide array 400 at the distal end 414 of the waveguide elements 410 (e.g., a sum of the distal areas, a distal sum of the distal areas, etc.). As shown in FIG. 15, a length L of the waveguide elements 410 is larger than the cross-sectional width d of the waveguide elements 410.

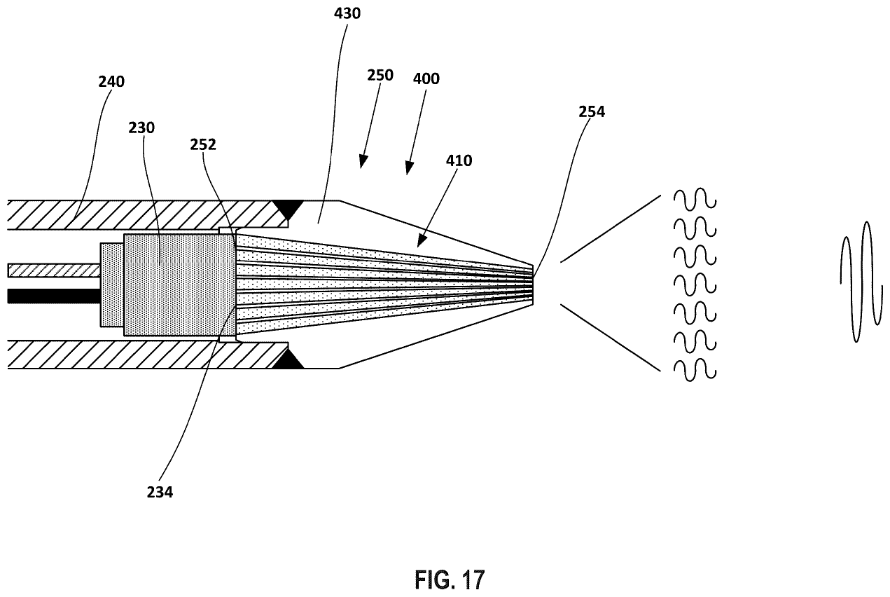

As shown in FIG. 17, as a result of the cross-sectional width d of the waveguide elements 410 being less than the wavelength of the ultrasonic soundwaves at the frequency of interest produced by the transducer 230, portions of the ultrasonic soundwaves traveling through each of the waveguide elements 410 will not disperse as they travel the length of the waveguide elements 410, this, coupled with the fact that the individual waveguides are of a similar length to each other, results in the portions of the ultrasonic soundwaves remaining in phase with each other on each side of the waveguide elements 410. For example, when the proximal ends 412 of the waveguide elements 410 receive a first set of ultrasonic soundwaves from the emission face of the transducer 230, a majority of the first set of ultrasonic soundwaves will remain in phase with each other when emitted from the distal end 414 of the waveguide elements 410 into the fluid 16. This may allow for the first set of the ultrasonic soundwaves emitted from the distal end 414 of the waveguide elements 410 of a first of the ultrasonic sensors 224 into the fluid 16 to be coherently received by a second of the ultrasonic sensors 224 included in the ultrasonic sensor pair 220 of the first of the ultrasonic sensors 224 such that the ultrasonic measurement system 210 may accurately determine the travel time of the first set of ultrasonic soundwaves between the ultrasonic sensor pair 220. As another example, when the distal ends 414 of the waveguide elements 410 receive a second set of ultrasonic soundwaves from the fluid 16, a majority of the second set of ultrasonic soundwaves will remain in phase with each other when provided by the waveguide elements 410 to the transducer 230. This may allow for the second set of the ultrasonic soundwaves that were emitted by a first of the ultrasonic sensors 224 into the fluid 16 to be received by the distal ends 414 of the waveguide elements 410 of a second of the ultrasonic sensors 224 included in the ultrasonic sensor pair 220 of the first of the ultrasonic sensors 224 to be coherently provided to the transducer 230 of the second of the ultrasonic sensors 224 such that the ultrasonic measurement system 210 may accurately determine the travel time of the first set of ultrasonic soundwaves between the ultrasonic sensor pair 220

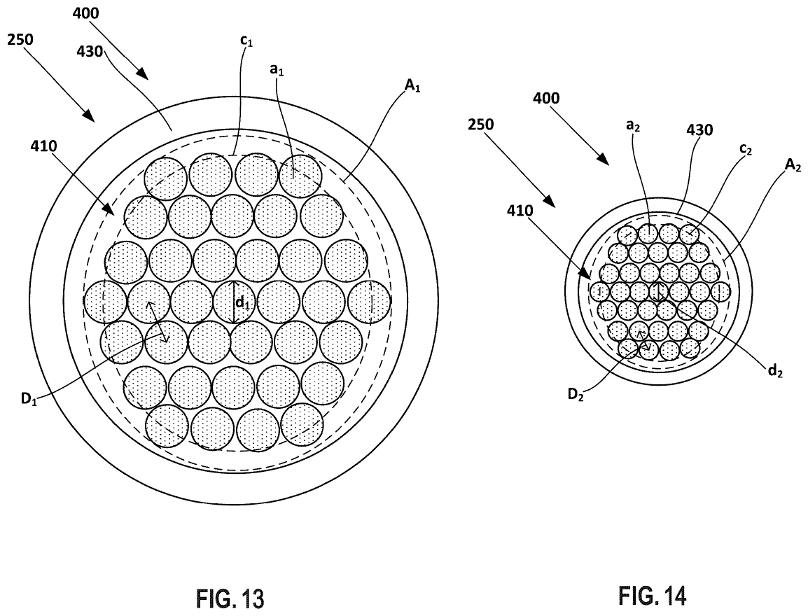

As shown in FIGS. 13 and 14, the waveguide elements 410 have a circular cross-section, according to some embodiments. When the waveguide elements 410 have a circular cross-section, the cross-sectional width d is a diameter of the waveguide elements 410. In other embodiments, the waveguide elements 410 may have other cross-sectional shape (e.g., hexagonal, triangular, square, etc.). When the waveguide elements 410 have one of the other cross-sectional shape, the cross-sectional width d is a maximum width of each of the cross sections of the waveguide elements 410 along the length L of the waveguide elements 410. For example, when the waveguide elements 410 have a square cross-section the cross-sectional width d is the distance between corners of the square cross-section of each of the waveguide elements 410 since that is the greatest cross-sectional width that can be formed across the square cross-section of the waveguide elements 410.

As shown in FIGS. 13 and 14, the cross-sectional width d of each of the waveguide elements 410 is a first cross-sectional width d₁ proximate the proximal ends 412 of the waveguide elements 410 and a second cross-sectional width d₂ proximate the distal ends 414 of the waveguide elements 410 (e.g., distal to the transducer 230, etc.). The first cross-sectional width d₁ is larger than the second cross-sectional width d₂. As a result of the first cross-sectional width d₁ being larger than the second cross-sectional width d₂, a first cross-sectional area a₁ of each of the waveguide elements 410 proximate the proximal ends 412 of the waveguide elements 410 is larger than a second cross-sectional area a₂ of each of the waveguide elements 410 proximate the distal ends 414 of the waveguide elements 410. Additionally, a first sum of the first cross-sectional areas a₁ of the waveguide elements 410 is larger than a second sum of the second cross-sectional areas a₂ of the waveguide elements 410.

As shown in FIGS. 13 and 14, since the first cross-sectional widths d₁ of the waveguide elements 410 are larger than the second cross-sectional widths d₂ of the waveguide elements 410, a first distance D₁ between centers of the waveguide elements 410 at the proximal ends 412 of the waveguide elements 410 may be larger than a second distance D₂ between the centers of the waveguide elements 410 at the distal ends 414 of the waveguide elements 410. For example, since the first cross-sectional widths d₁ of the waveguide elements 410 are larger than the second cross-sectional widths d₂ of the waveguide elements 410, the centers of the waveguide elements 410 may be closer together at the distal ends 414 of the waveguide elements 410 than at the proximal ends 412 of the waveguide elements 410.

As shown in FIGS. 13 and 14, since the first cross-sectional widths d₁ of the waveguide elements 410 are larger than the second cross-sectional widths d₂ of the waveguide elements 410, a first area A₁ (e.g., a first footprint, etc.) containing the waveguide elements 410 proximate the proximal ends 412 of the waveguide elements 410 is larger than a second area A₂ (e.g., a second footprint, etc.) containing the waveguide elements 410 proximate the distal ends 414 of the waveguide elements 410. As shown in FIGS. 13 and 14, since the first cross-sectional widths d₁ of the waveguide elements 410 are larger than the second cross-sectional widths d₂ of the waveguide elements 410, a first circumscribed area c₁ defined by a first circle extending through centers of peripheral (e.g., outer, etc.) of the waveguide elements 410 proximate the proximal ends 412 of the wave guide elements 410 is greater than a second circumscribed area c₂ defined by a second circle extending through the centers of the peripheral of the waveguide elements 410 proximate the distal ends 414 of the waveguide elements 410.

The waveguide elements 410 have the cross-sectional width d that smaller than a wavelength of the ultrasonic signal in the frequency range of interest produced by the transducer 230. Signal wavelengths that are smaller than the cross-sectional width d of the waveguide elements 410 will be subject to dispersion and will effectively be attenuated. As a result, the waveguide elements 410 may be sized appropriately for the signal frequency of the ultrasonic signals of interest. For example, there may be a relationship between an increase in the signal frequency of the ultrasonic signals and a decrease in the cross-sectional width d of the waveguide elements 410.

According to the embodiment shown in FIGS. 13 and 14, the waveguide elements 410 are arranged with a hexagonal cross-sectional pattern where the waveguide elements 410 generally form a hexagon along a cross-section of the waveguide array 400. For example, as shown in FIGS. 13 and 14, the waveguide elements 410 may be arranged such that there are generally six outside edges around the waveguide elements 410 along the cross-section of the waveguide array 400. In other instances, the waveguide elements 410 may be arranged with another cross-sectional pattern where the waveguide elements 410 generally form another shape (e.g., a square, a circle, an octagon, a triangle, etc.) along the cross-section of the waveguide array 400. For example, the waveguide elements 410 may be arranged in a square where the waveguide elements 410 are arranged in an equal number of columns and rows and there are generally four outside edges around the waveguide elements 410 along the cross-section of the waveguide array 400. In still other embodiments, the waveguide elements 410 are arranged in a random or substantially random pattern. In other embodiments, the individual of the waveguide elements 410 are not identical as long as each of the waveguide elements 410 are of similar length and have a small width relative to the wavelength in the frequency range of interest.

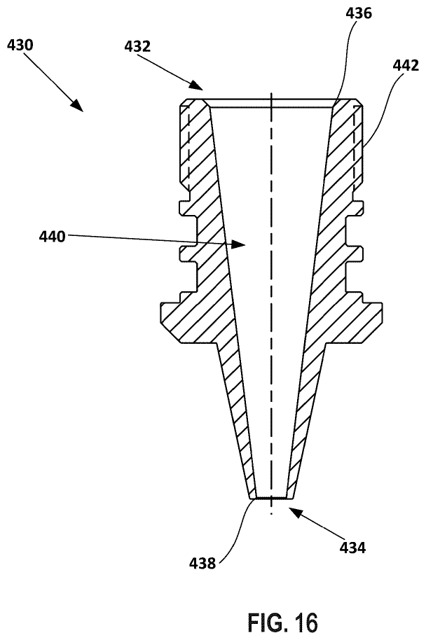

As shown in FIGS. 11, 12, 16, and 17, the waveguide array 400 includes a waveguide housing 430 (e.g., housing tip, etc.) configured to receive the waveguide elements 410, according to some embodiments. The waveguide housing 430 includes a housing proximal end 432 and a housing distal end 434 opposing the housing proximal end 432. The variation of the width d of the waveguide elements 410 allows for a first cross-sectional area of the housing distal end 434 of the waveguide housing 430 to be smaller than a second cross-sectional area of housing proximal end 432 of the waveguide housing 240. As shown in FIG. 3, as a result of the first cross-sectional area of the housing distal end 434 being smaller than the second cross-sectional area of the housing proximal end 432, a size of the cavity 212 in front of the housing distal end 434 may be reduced compared to when the first cross-sectional area of the housing distal end 434 is the same size as the second cross-sectional area of the housing proximal end 432 (e.g., in the planar window 260, etc.). In some instances, the housing proximal end 432 is configured to interface with the transducer 230. The housing proximal end 432 defines a proximal aperture 436. In some instances, the housing distal end 434 is configured to interface with the fluid 16. The housing distal end 434 defines a distal aperture 438. The waveguide housing 430 also defines a housing cavity 440 (e.g., an opening, etc.) extending between the proximal aperture 436 and the distal aperture 438 that receives the waveguide elements 410. For example, the waveguide elements 410 may be disposed within the housing cavity 440 of the waveguide housing 430.

In some instances, the proximal ends 412 of the waveguide elements 410 align with the proximal aperture 436 of the waveguide housing 430 when the waveguide housing 430 receives the waveguide elements 410. For example, the proximal ends 412 of the waveguide elements 410 may be substantially flush with the proximal aperture 436 of the waveguide housing 430 when the waveguide housing 430 receives the waveguide elements 410. In some instances, the distal ends 414 of the waveguide elements 410 align with the distal aperture 438 of the waveguide housing 430 when the waveguide housing 430 receives the waveguide elements 410. For example, the distal ends 414 of the waveguide elements 410 may be substantially flush with the distal aperture 438 of the waveguide housing 430 when the waveguide housing 430 receives the waveguide elements 410. In some instances, a first area of the proximal aperture 436 of the waveguide housing 430 is larger than a second area of the distal aperture 438 of the waveguide housing 430.

As shown in FIGS. 11, 12, 16, and 17, the waveguide housing 430 defines a housing interface 442 configured to engage the housing 240 when the waveguide array 400 is coupled to the housing 240, according to some embodiments. For example, the housing interface 442 may define threads configured to engage threads defined by the housing 240 to couple the waveguide array 400 to the housing 240. The housing interface 442 of the waveguide housing 430 may be configured to align the proximal ends 412 of the waveguide elements 410 with the emission face of the transducer 230 when the waveguide housing 430 is coupled to the housing 240.

In some instances, the waveguide array 400 includes a filling 470 disposed within the housing cavity 440 of the waveguide housing 430. The filling 470 may fill gaps between the waveguide elements 410 disposed within the waveguide housing 430. For example, portions of the filling 470 may be disposed between the waveguide elements 410 when the waveguide elements 410 contact each other. As another example, portions of the filling 470 may be disposed between the waveguide elements 410 and separate the waveguide elements 410 from each other (e.g., when the waveguide elements 410 do not contact each other, etc.). A first portion of a cross-sectional area of the waveguide array 400 including the waveguide elements 410 may be greater than a second portion of the cross-sectional area of the waveguide array 400 including the filling 470. For example, the wave guide elements 410 may make up a majority of the cross-section of the waveguide array 400 and the filling 470 may make up a minority of the cross-section of the waveguide array 400.

In some instances, the waveguide elements 410 may have a first acoustic impedance (e.g., a first sound resistance, a first sound impedance, etc.) that is greater than (e.g., higher than, etc.) a second acoustic impedance (e.g., a second sound resistance, a first sound impedance, etc.) of the filling 470. For example, when the first acoustic impedance of the waveguide elements 410 is greater than the second acoustic impedance of the filling 470 may result in a greater effectiveness of the waveguide array 400 to convey the ultrasonic soundwaves along the waveguide array 400 through the waveguide elements 410 than when the first acoustic impedance of the waveguide elements 410 is less than the second acoustic impedance of the filling 470. In some instances, the filling 470 may be a liquid or gaseous media such as air or nitrogen. In some instances, the filling 470 may be a vacuum. In other instances, the filling 470 is a solid material such as an epoxy filler.

In some instances, the waveguide array 400 is assembled through additive manufacturing. For example, the waveguide array 400 may be assembled using three dimensional (3D) printing, selective laser sintering, or other similar processes. When the waveguide array 400 is assembled through additive manufacturing, the waveguide housing 430 may be formed from a first material with a first acoustic impedance and the waveguide elements 410 may be formed from a second material with a second acoustic impedance higher than the first acoustic impedance of the waveguide housing 430.

### Waveguide Array Operation

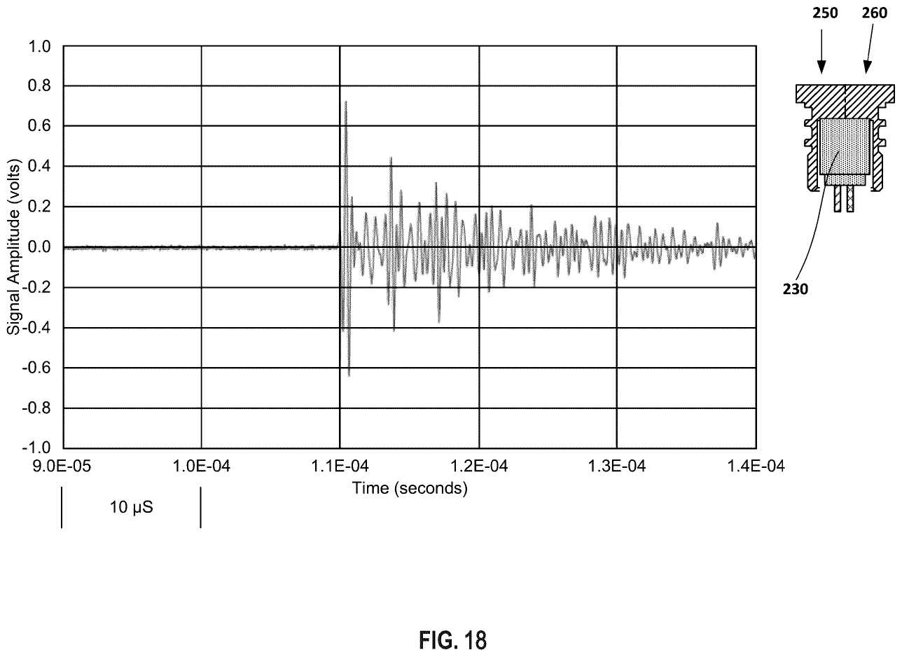

In FIG. 18, a first graph of a waveform is shown corresponding to the ultrasonic soundwaves of the ultrasonic measurement system 210 that includes the prior art embodiment of the ultrasonic sensors 224 including the ultrasonic window 250 configured as the planar window 260. The waveform is of an ultrasonic signal traveling along the ultrasonic path 222 from a first of the ultrasonic sensors 224 (e.g., an emitting ultrasonic sensor, etc.) to a second of the ultrasonic sensors 224 (e.g., a receiving ultrasonic sensor, etc.) through the fluid 16. For example, the first of the ultrasonic sensors 224 may be emitted from the outward face 254 of the first of the ultrasonic sensors 224 and received by the outward face 254 of the second of the ultrasonic sensors 224. The waveform of the ultrasonic soundwaves shown in FIG. 18 is shown as signal amplitude in volts corresponding to the ultrasonic soundwaves versus time and may be generated by the transducer 230 of the second of the ultrasonic sensors 224. For example, the voltage corresponding to the ultrasonic soundwaves shown in FIG. 18 may be generated by the piezoelectric element of the transducer 230 of the second of the ultrasonic sensors 224 of the ultrasonic sensor pair 220 vibrating and generating a voltage in response to receiving the ultrasonic soundwaves from the first of the ultrasonic sensors 224 of the ultrasonic sensor pair 220. The waveform shown in FIG. 18 shows characteristics that are desirable for determining a velocity and/or a flow rate of the fluid 16 based on the travel time of the ultrasonic soundwaves from the first of the ultrasonic sensors 224 to the second of the ultrasonic sensors 224 through the fluid 16 due to the first of the ultrasonic sensors 224 and the second of the ultrasonic sensors 224 including the planar window 260.

First, the waveform shown in FIG. 18 corresponding to the ultrasonic soundwaves includes low noise preceding the arrival of the ultrasonic soundwaves at the first of the ultrasonic sensors 224, allowing for the ultrasonic measurement system 210 to determine when the ultrasonic soundwaves are received by the first of the ultrasonic sensors 224. In an instances where the waveform of the ultrasonic soundwaves does not include low noise preceding the arrival of the ultrasonic soundwaves at the first of the ultrasonic sensors 224, the ultrasonic measurement system 210 may not be able to determine when the ultrasonic soundwaves are received by the first of the ultrasonic sensors 224, making it difficult to determine the travel time of the ultrasonic soundwaves between the second of the ultrasonic sensor 224 and the first of the ultrasonic sensors 224. Even when an ultrasonic signal can be detected, a lower signal-to-noise ratio can also result in lower accuracy in the transit time measurement.

Second, the waveform shown in FIG. 18 corresponding to the ultrasonic soundwaves includes a fast rise-time and clear differentiation between principal peaks in the leading edge corresponding to the arrival of the ultrasonic soundwaves. The waveform of FIG. 18 includes three of the principal peaks (e.g., one positive principal peak and two negative principal peaks, etc.) in the leading edge that are clearly distinguishable from the noise preceding the arrival of the ultrasonic soundwaves. The fast rise-time may be utilized by the ultrasonic measurement system 210 to determine unambiguously when the ultrasonic soundwaves are received by the first of the ultrasonic sensors 224. In cases where the rise time is slower, comprising a larger number of waveform cycles between the first cycle above the noise and the maximum peak, determining an exact arrival time can be more difficult.

Third, the waveform shown in FIG. 18 corresponding to the ultrasonic soundwaves includes trailing peaks with trail amplitudes that are lower than peak amplitudes of the peaks in the leading-edge. This may allow for more efficient signal processing of the ultrasonic soundwaves by the ultrasonic measurement system 210. For example, when the trailing amplitudes of the waveform are lower than the peak amplitudes in the leading-edge of the waveform, the ultrasonic measurement system 210 may be able to more easily identify when the ultrasonic soundwaves are received by the first of the ultrasonic sensors 224 to determine the travel time of the ultrasonic soundwaves between the second of the ultrasonic sensors 224 and the first of the ultrasonic sensors 224. As another example, when the trailing amplitudes of the waveform are lower than the peak amplitudes of the waveform, the ultrasonic measurement system 210 is less likely to be adversely affected by the influence of secondary reflections (e.g., an echo reflected off of the inside surface of the wall of the conduit 12, reverberation within the window, etc.), which can combine with trailing peaks.

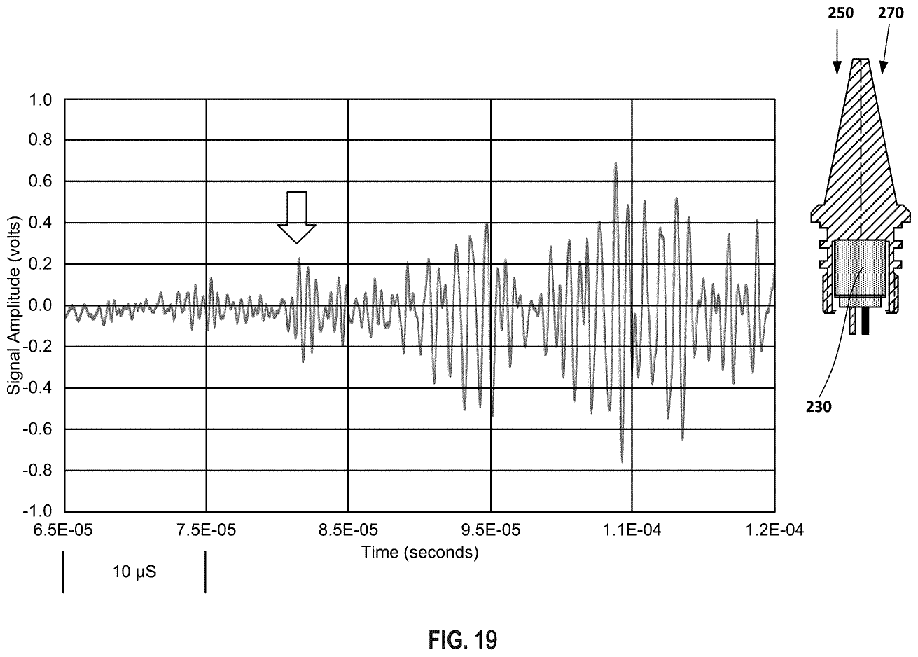

In FIG. 19, a second graph of the waveform is shown corresponding to the ultrasonic soundwaves of the ultrasonic measurement system 210 including the example of the ultrasonic sensors 224 that include the ultrasonic window 250 configured as the monolithic conical window 270. The waveform is of an ultrasonic signal traveling along the ultrasonic path 222 from a first of the ultrasonic sensors 224 (e.g., an emitting ultrasonic sensor, etc.) to a second of the ultrasonic sensors 224 (e.g., a receiving ultrasonic sensor, etc.) through the fluid 16. For example, the first of the ultrasonic sensors 224 may be emitted from the outward face 254 of the first of the ultrasonic sensors 224 and received by the outward face 254 of the second of the ultrasonic sensors 224. Similar to FIG. 18, the waveform of the ultrasonic soundwaves shown in FIG. 19 is shown as signal amplitude in volts corresponding to the ultrasonic soundwaves versus time and may be generated by the transducer 230 of the first of the ultrasonic sensors 224. The waveform shown in FIG. 19 shows characteristics that are not be desirable for determining the velocity and/or the flow rate of the fluid 16 based on the travel time of the ultrasonic soundwaves from the first of the ultrasonic sensors 224 to the second of the ultrasonic sensors 224 through the fluid 16 due to the first of the ultrasonic sensors 224 and the second of the ultrasonic sensors 224 including the monolithic conical window 270.

First, the waveform shown in FIG. 19 corresponding to the ultrasonic soundwaves includes noise preceding the arrival of the ultrasonic soundwaves at the first of the ultrasonic sensors with a noise amplitude that is similar to a peak amplitude of a leading-edge peak corresponding to the arrival of the ultrasonic soundwave, which may make it difficult for the ultrasonic measurement system 210 to determine when the ultrasonic soundwaves are received by the first of the ultrasonic sensors 224. The noise amplitude is similar to the peak amplitude due to the wave components of the ultrasonic soundwaves emitted by the second of the ultrasonic sensor 224 and received by the first of the ultrasonic sensors 224 being out of phase due to the first of the ultrasonic sensors 224 and the second of the ultrasonic sensors 224 employing the monolithic conical window 270.

Second, the waveform shown in FIG. 19 corresponding to the ultrasonic soundwaves includes trailing amplitudes of trailing peaks that are higher than the peak amplitudes in the leading edge, which also may make it difficult for the ultrasonic measurement system 210 to determine when the ultrasonic soundwaves are received by the first of the ultrasonic sensors 224. Similar to the noise amplitudes being similar to the peak amplitudes, the trailing amplitudes are higher than the peak amplitudes due to the wave components in the leading-edge the ultrasonic soundwaves emitted by the second of the ultrasonic sensor 224 and received by the first of the ultrasonic sensors 224 being out of phase, and reverberations combining in phase, owing to the first of the ultrasonic sensors 224 and the second of the ultrasonic sensors 224 employing the monolithic conical window 270.

The preceding discussion shows how the waveforms of the ultrasonic signals produced by the ultrasonic sensors 224 including the planar window 260 result in desirable signal characteristics, but place undesirable constraints on the size of the cavity 212 at the distal end of the housing 240, and how the monolithic conical window 270 include characteristics that are undesirable for determining the velocity and/or the flow rate of the fluid 16 based on the travel time of the ultrasonic soundwaves from the first of the ultrasonic sensors 224 to the second of the ultrasonic sensors 224 through the fluid 16. The following discussion explains how the waveforms of the ultrasonic signals produced by the ultrasonic sensors 224 including the waveguide array 400 include characteristics that are desirable for determining the velocity and/or the flow rate of the fluid 16 based on the travel time of the ultrasonic soundwaves from the first of the ultrasonic sensors 224 to the second of the ultrasonic sensors 224 through the fluid 16, and enable use of a smaller size of the cavity 212 at the distal end of the housing 240.

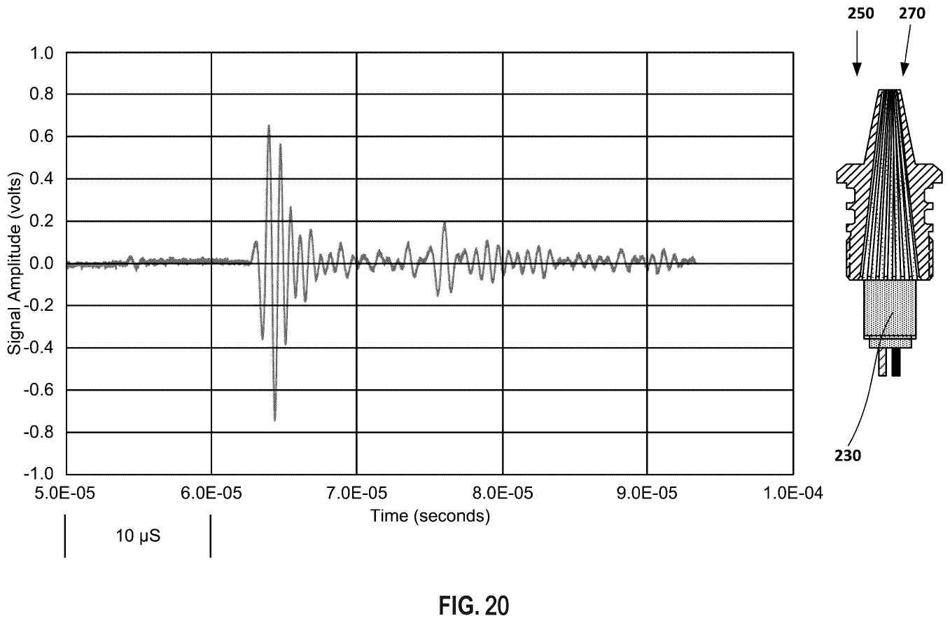

In FIG. 20, a third graph of a waveform is shown corresponding to ultrasonic soundwaves of the ultrasonic measurement system 210 including the embodiment of the ultrasonic sensors 224 that include the ultrasonic window 250 configured as the waveguide array 400. The waveform is of an ultrasonic signal traveling along the ultrasonic path 222 from a first of the ultrasonic sensors 224 (e.g., an emitting ultrasonic sensor, etc.) to a second of the ultrasonic sensors 224 (e.g., a receiving ultrasonic sensor, etc.) through the fluid 16. For example, the first of the ultrasonic sensors 224 may be emitted from the outward face 254 of the first of the ultrasonic sensors 224 and received by the outward face 254 of the second of the ultrasonic sensors 224. Similar to FIGS. 18 and 19, the waveform of the ultrasonic soundwaves shown in FIG. 20 is shown as signal amplitude in volts corresponding to the ultrasonic soundwaves versus time and may be generated by the transducer 230 of the first of the ultrasonic sensors 224. Unlike FIG. 19, the waveform shown in FIG. 20 shows characteristics that are desirable for determining the velocity and/or the flow rate of the fluid 16 based on the travel time of the ultrasonic soundwaves from the first of the ultrasonic sensors 224 to the second of the ultrasonic sensors 224 through the fluid 16 due to the first of the ultrasonic sensors 224 and the second of the ultrasonic sensors 224 including the waveguide array 400.

First, the waveform shown in FIG. 20 corresponding to the ultrasonic soundwaves includes low noise preceding the arrival of the ultrasonic soundwaves at the first of the ultrasonic sensors 224, allowing for the ultrasonic measurement system 210 to determine when the ultrasonic soundwaves are received by the first of the ultrasonic sensors 224. Second, the waveform shown in FIG. 20 corresponding to the ultrasonic soundwaves includes a fast rise-time and clear differentiation between peaks in the leading edge corresponding to the arrival of the ultrasonic soundwave. Third, the waveform shown in FIG. 20 corresponding to the ultrasonic soundwaves includes trailing peaks with amplitudes that are lower than the amplitude of the peaks in the leading-edge. As a result, the first of the ultrasonic sensors 224 including the waveguide array 400 and the second of the ultrasonic sensors 224 including the waveguide array 400 may be used in the ultrasonic measurement system 210 to accurately measure the travel time of ultrasonic soundwaves between the first of the ultrasonic sensors 224 and the second of the ultrasonic sensors 224 while enabling the size of the cavity 212 at the distal end of the housing 240 to be reduced, thus overcoming the size constraints imposed on the cavity 212 by the planar windows 250 and the poor signal characteristics associated with the monolithic conical window 270.

### Configuration of Exemplary Embodiments

As utilized herein, the terms “approximately”, “about”, “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the elements of the systems and methods as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A waveguide array configured to convey ultrasonic soundwaves, the waveguide array comprising:
a plurality of waveguide elements, each of the waveguide elements defining a proximal end configured to receive the ultrasonic soundwaves from a transducer and a distal end opposing the proximal end, wherein a cross-sectional width of each of the waveguide elements is less than a wavelength of the ultrasonic soundwaves, wherein an inward area of the waveguide array at the proximal ends of the waveguide elements is greater than an outward area of the waveguide array at the distal ends of the waveguide elements, wherein first distances between centers of adjacent of the waveguide elements at the proximal ends of the waveguide elements are greater than second distances between the centers of the adjacent of the waveguide elements at the distal ends of the waveguide elements.

2. The waveguide array of claim 1, wherein a cross-sectional area of each of the waveguide elements varies along a length of each of the waveguide elements; and
wherein a first sum of the cross-sectional areas of the waveguide elements at the proximal ends of the waveguide elements is greater than a second sum of the cross-sectional areas of the waveguide elements at the distal ends of the waveguide elements.

3. The waveguide array of claim 1 further comprising:
a waveguide housing comprising a housing proximal end configured to interface with the transducer and a housing distal end opposing the housing proximal end, the waveguide housing defining an opening extending through waveguide housing between the housing proximal end and the housing distal end, wherein the opening is larger proximate the housing proximal end than proximate the housing distal end;
wherein the waveguide elements are disposed within the opening of the waveguide housing.

4. The waveguide array of claim 3, further comprising:
a filling disposed within the opening of the waveguide housing;
wherein a first acoustic impedance of the waveguide elements is higher than a second acoustic impedance of the filling.

5. The waveguide array of claim 4, wherein the filling is disposed between the waveguide elements.

6. The waveguide array of claim 3, wherein:
the transducer is disposed within a housing; and
the housing proximal end of the waveguide housing is configured to couple to the housing to align the proximal ends of the waveguide elements with the transducer.

7. The waveguide array of claim 1, wherein at least one of the proximal ends or the distal ends of each of the waveguide elements are coupled to form a continuous surface at the at least one of the proximal ends or the distal ends of the waveguide elements.

8. The waveguide array of claim 1, wherein first distances between centers of adjacent of the waveguide elements at the proximal ends of the waveguide elements are greater than second distances between the centers of the adjacent of the waveguide elements at the distal ends of the waveguide elements.

9. An ultrasonic sensor system comprising:
a pair of ultrasonic sensors, each of the ultrasonic sensors comprising:
a transducer configured to produce ultrasonic soundwaves and receive the ultrasonic soundwaves from the transducer of the other of the ultrasonic sensors, and
a waveguide array aligned with the transducer, the waveguide array comprising:
a waveguide housing comprising a housing proximal end configured to interface with the transducer and a housing distal end opposing the housing proximal end, wherein a first cross-sectional area of the housing distal end of the waveguide housing is smaller than a second cross-sectional area of the housing proximal end of the waveguide housing; and
a plurality of waveguide elements disposed within the waveguide housing, wherein a first cross-sectional width of each of the waveguide elements proximate the housing proximal end of the housing is larger than a second cross-sectional width of each of the waveguide elements proximate the housing distal end of the housing.

10. The ultrasonic sensor system of claim 9, further comprising a controller configured to:
provide, to the transducer of a first of the ultrasonic sensors, a command for the transducer of the first of the ultrasonic sensors to produce the ultrasonic soundwaves, wherein the transducer of the first of the ultrasonic sensors is configured to provide the ultrasonic soundwaves through the waveguide array of the first of the ultrasonic sensors into a flow of a fluid through a conduit;
receive, from the transducer of a second of the ultrasonic sensors, data corresponding to the ultrasonic soundwaves received by the second of the transducer of the second of the ultrasonic sensors through the waveguide array of the second of the ultrasonic sensors; and
determine, based on the data, at least one of a property of the fluid or a property of the flow of the fluid between the first of the ultrasonic sensors and the second of the ultrasonic sensors.

11. The ultrasonic sensor system of claim 10, wherein at least one of the property of the fluid or the property of the flow of the fluid is a velocity of the fluid flowing between the first of the ultrasonic sensors and the second of the ultrasonic sensors.

12. The ultrasonic sensor system of claim 10, wherein each of the waveguide arrays are at least one of partially disposed in a cavity in communication with the conduit or extending outside of an inner surface of the conduit.

13. The ultrasonic sensor system of claim 9, wherein a first sum of first cross-sectional areas of the waveguide elements at proximal ends of the waveguide elements proximate the transducer is greater than a second sum of second cross-sectional areas of the waveguide elements at distal ends of the waveguide elements.

14. The ultrasonic sensor system of claim 9, wherein the waveguide housing defines an opening extending from the housing proximal end to the housing distal end;
the waveguide array further comprises a filling disposed within the opening of the waveguide housing; and
a first acoustic impedance of the waveguide elements is higher than a second acoustic impedance of the filling.

15. The ultrasonic sensor system of claim 9, wherein a first cross-sectional area of the housing distal end of the waveguide housing is smaller than a second cross-sectional area of the housing proximal end of the waveguide housing.

16. A method of measuring at least one of a property of a fluid or a property of a flow of the fluid, the method comprising:
providing, via a controller, a command to a first transducer for the first transducer to produce ultrasonic soundwaves, wherein the first transducer is configured to provide the ultrasonic soundwaves to a first waveguide array, the first waveguide array comprising:
a plurality of first waveguide elements, wherein a cross-sectional width of each of the first waveguide elements is less than a wavelength of the ultrasonic soundwaves, wherein a first cross-sectional area of the first waveguide array proximate the first transducer is greater than a second cross-sectional area of the first waveguide array distal to the first transducer, wherein a first area of a first circumscribed circle extending through centers of peripheral of the first waveguide elements proximate the first transducer is greater than a second area of a second circumscribed circle extending through the centers of the peripheral of the first waveguide elements distal to the first transducer;
receiving, from a second transducer, data corresponding to the ultrasonic soundwaves received by the second transducer from a second waveguide array, the second waveguide array comprising:
a plurality of second waveguide elements, wherein the cross-sectional width of each of the second waveguide elements is less than the wavelength of the ultrasonic soundwaves, wherein a first cross-sectional area of the second waveguide array proximate the second transducer is greater than a second cross-sectional area of the second waveguide array distal to the second transducer; and
determining, based on the data, the at least one of the property of the fluid or the property of the flow of the fluid between the first transducer and the second transducer.

17. The method of claim 16, wherein the flow of the fluid is through a conduit;
wherein the first waveguide array is at least one of partially disposed in a first cavity in communication with the conduit or extending outside of an inner surface of the conduit; and
wherein the second waveguide array is at least one of partially disposed in a second cavity in communication with the conduit or extending outside of the inner surface of the conduit.

18. The method of claim 16, wherein:
first distances between centers of adjacent of the first waveguide elements proximate the first transducer are greater than second distances between the centers of the adjacent of the first waveguide elements distal to the first transducer; and
third distances between centers of adjacent of the second waveguide elements proximate the second transducer are greater than fourth distances between the centers of the adjacent of the second waveguide elements distal to the second transducer.

19. The method of claim 16, wherein the at least one of the property of the fluid or the property of the flow of the fluid is a velocity of the flow of the fluid between the first waveguide array and the second waveguide array.

20. The method of claim 16, wherein a third area of a third circumscribed circle extending through centers of peripheral of the second waveguide elements proximate the second transducer is greater than a fourth circumscribed circle extending through the centers of the peripheral of the second waveguide elements distal to the second transducer.
